(19) United States
(12) Patent Application Publication
(10) Pub. No.: US 2017/0372092 A1
(43) Pub. Date: Dec. 28, 2017

(54) INFORMATION PROCESSING SYSTEM, TERMINAL, AND DETERMINATION APPARATUS

(71) Applicant: FUJITSU LIMITED, Kawasaki-shi (JP)

(72) Inventor: Hiroshi DOHI, Kawasaki (JP)

(73) Assignee: FUJITSU LIMITED, Kawasaki-shi (JP)

(21) Appl. No.: 15/632,902

(22) Filed: Jun. 26, 2017

(30) Foreign Application Priority Data
Jun. 28, 2016 (JP) 2016-127541

(51) Int. Cl. G06F 21/62; G06F 3/06

(52) U.S. Cl. CPC G06F 21/6227; G06F 3/0643

(57) ABSTRACT

An information processing system including an information processing apparatus, a terminal, and a determination apparatus, wherein the information processing apparatus is configured to generate first information and second information based on first decryption information and specified condition information, an encrypted data file is decrypted by using the first decryption information, transmit the first information to the terminal, and transmit the second information to the determination apparatus, wherein the terminal is configured to receive the first information, and transmit the first information and input information to the determination apparatus when the terminal requests the decryption of the encrypted data file, and wherein the determination apparatus is configured to generate second decryption information based on the first information, the second information and the input information, and transmit the generated second decryption information, the transmitted second decryption information being used for the decryption of the encrypted data file.

### CROSS-REFERENCE TO RELATED APPLICATION

This application is based upon and claims the benefit of priority of the prior Japanese Patent Application No. 2016-127541, filed on Jun. 28, 2016, the entire contents of which are incorporated herein by reference.

### FIELD

The embodiments discussed herein are related to an information processing system, a terminal, and a determination apparatus.

### BACKGROUND

In organizations such as companies, access restrictions are imposed on electronic files, which store documents and the like, by using techniques of user authentication, encryption, and the like. Thus, accesses to the files by unauthorized persons are limited.

For example, when an authorized user carries out an electronic file having been encrypted (hereinafter, referred to “encrypted file”) from an organization and views the encrypted file, the authorized user stores the encrypted file in a specified terminal (for example, a notebook personal computer (PC) or a tablet). The user then decrypts the encrypted file using an acquired decryption key to view the file.

Such a technique is disclosed in, for example, Japanese Laid-open Patent Publication No. 2000-163379.

### SUMMARY

According to an aspect of the invention, an information processing system, including an information processing apparatus including a first memory and a first processor coupled to the first memory, a terminal including a second memory and a second processor coupled to the second memory, and a determination apparatus including a third memory and a third processor coupled to the third memory, wherein the first processor is configured to generate first information and second information based on first decryption information and specified condition information, an encrypted data file is decrypted by using the first decryption information, the specified condition information indicating a condition for allowing the terminal to encrypted data file, transmit the first information to the terminal, and transmit the second information to the determination apparatus, wherein the second processor is configured to receive the first information transmitted from the information processing apparatus, and transmit the first information and input information to the determination apparatus when the terminal requests the decryption of the encrypted data file, and wherein the third processor is configured to generate second decryption information based on the first information, the second information and the input information, the generated second decryption information being identical when the input information matches the specified condition information, and transmit the generated second decryption information, the transmitted second decryption information being used for the decryption of the encrypted data file.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a configuration example of an information processing system according to a first embodiment;

FIG. 2 is a diagram describing an operation example of a block cipher (the electronic codebook (ECB) mode);

FIG. 3 is a diagram describing an operation example of a block cipher (the cipher block chaining (CBC) mode);

FIG. 4 is a block diagram illustrating a functional configuration example of a file management apparatus according to the first embodiment;

FIG. 5 is a diagram illustrating an example of file management information;

FIG. 6 is a block diagram illustrating a configuration example of an operation processing unit of a file management apparatus;

FIG. 7 is a diagram illustrating examples of access permission conditions;

FIG. 8 is a diagram illustrating an example of access permitting apparatus information;

FIG. 9 is a diagram illustrating an example of accessing apparatus information;

FIG. 10 is a block diagram illustrating a configuration example of a processing unit of a file management apparatus;

FIG. 11 is a diagram illustrating examples of condition type;

FIG. 12 is a block diagram illustrating a functional configuration example of the access permitting apparatus according to the first embodiment;

FIG. 13 is a block diagram illustrating a functional configuration example of an access permission determination unit of the access permitting apparatus;

FIG. 14 is a block diagram illustrating a functional configuration of the access permission determination unit of the access permitting apparatus;

FIG. 15 is a diagram illustrating an example of management information;

FIG. 16 is a block diagram illustrating a functional configuration example of the accessing apparatus according to the first embodiment;

FIG. 17 is a block diagram illustrating a configuration example of a converter of the file management apparatus;

FIG. 18 is a block diagram illustrating a configuration example of a converter of the access permitting apparatus;

FIG. 19 is a block diagram illustrating a configuration example of the converter of the file management apparatus;

FIG. 20 is a block diagram illustrating a configuration example of the converter of the access permitting apparatus;

FIG. 21 is a block diagram illustrating a configuration example of the converter of the file management apparatus;

FIG. 22 is a block diagram illustrating a configuration example of the converter of the access permitting apparatus;

FIG. 23 is a block diagram illustrating a configuration example of the converter of the file management apparatus;

FIG. 24 is a block diagram illustrating a configuration example of the converter of the access permitting apparatus;

FIG. 25 is a block diagram illustrating a configuration example of a decryption information generator of the file management apparatus;

FIG. 26 is a block diagram illustrating a configuration example of an access permission determination unit of the access permitting apparatus;

FIG. 27 is a flowchart illustrating an operation example of a file registration process;

FIG. 28 is a flowchart illustrating an operation example of an encrypted file distribution process;

FIG. 29 is a diagram illustrating an operation example of the encrypted file distribution process;

FIG. 30 is a flowchart illustrating an operation example of a file viewing process;

FIG. 31 is a diagram describing an operation example of the file viewing process;

FIG. 32 is a diagram describing an operation example of the file viewing process;

FIG. 33 is a flowchart illustrating an operation example of a process to regularly confirm whether the access permission condition is satisfied;

FIG. 34 is a diagram describing an operation example of the regular confirmation process;

FIG. 35 is a flowchart illustrating an operation example of an access permission condition updating process;

FIG. 36 is a diagram describing an operation example of the access permission condition updating process;

FIG. 37 is a flowchart illustrating an operation example of an access permission condition canceling process;

FIG. 38 is a diagram describing an operation example of the access permission condition canceling process; and

FIG. 39 is a block diagram illustrating a hardware configuration example of each apparatus of the information processing system.

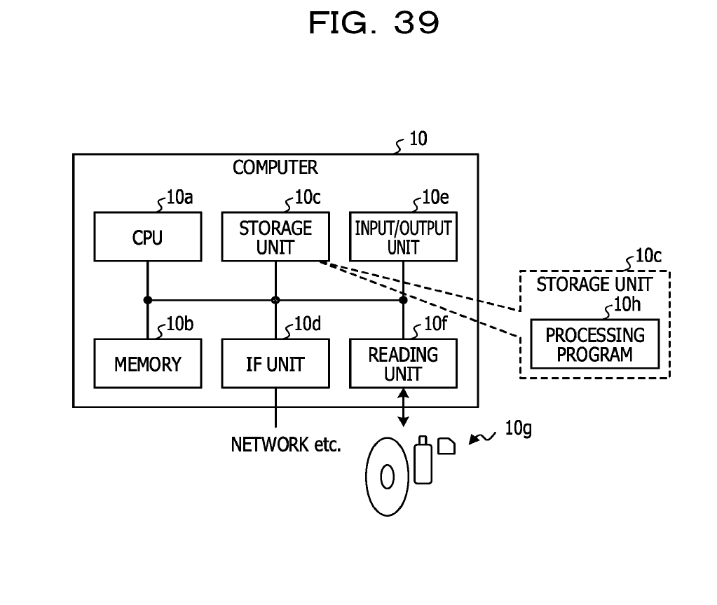

### DESCRIPTION OF EMBODIMENTS

A terminal of a user who is permitted to access an encrypted file stores the file together with a decryption key to be used to decrypt the encrypted file. When the user intends to unauthorizedly view the file for malicious reasons, the user may easily decrypt the encrypted file. It is difficult to avoid such unauthorized viewing. Moreover, when the user does not have a malicious intent but loses the terminal, decryption key, or the like, it is difficult to keep the file from being viewed once the terminal or the like is lost.

An object of an aspect of the embodiment is to reduce the security risk concerning encrypted files.

In addition, another object of the embodiment is to provide operational effects which are derived from each configuration illustrated in later-described embodiments and are not obtained by any conventional technique.

Hereinafter, a description is given of embodiments of the disclosure with reference to the drawings. The embodiments described below are just illustrative and do not intend to exclude various modifications and application of techniques not clearly illustrated. For example, the embodiments may be variously modified without departing from the scope. In the drawings used in the following description, the portions given the same reference numerals represent the same or similar portions unless otherwise noted.

### [1] First Embodiment

8 1-1] Configuration Example of Information Processing System

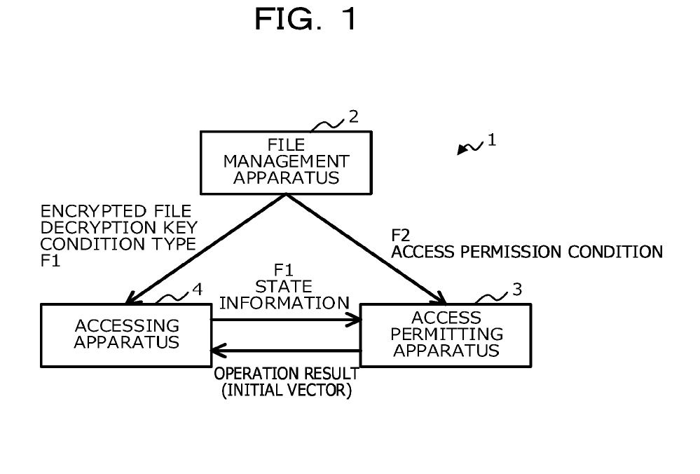

As illustrated in FIG. 1, an information processing system 1 according to a first embodiment illustratively includes a file management apparatus 2, an access permitting apparatus 3, and an accessing apparatus 4. In the information processing system 1, the file management apparatus 2 may include multiple file management apparatuses 2, the access permitting apparatus 3 may include multiple access permitting apparatuses 3, and the accessing apparatus 4 may include multiple accessing apparatuses 4.

The file management apparatus 2 is an example of an information processing apparatus configured to manage file management information and access permission condition. The information processing apparatus is one of various types of computers such as PCs, servers, and storage devices. The storage devices may be redundant arrays of inexpensive disks (RAID) devices.

The access permission condition is an example of a condition under which decryption of an encrypted file is permitted. The condition is set for the accessing apparatus 4 or the user. The access permission condition is a condition concerning at least one of geographical position information of the place where the file is permitted to be decrypted, hours when the file is viewable, the number of times that the file is permitted to be accessed, the user ID, the apparatus ID of the accessing apparatus 4, and the like.

The file management information may include at least one of an encrypted file obtained by encrypting a file (a document, for example), an encryption key used to encrypt the file, and an initial vector. The initial vector is an example of information used to encrypt a file together with an encryption key and is an example of decryption information used to decrypt the encrypted file together with a decryption key. Hereinafter, the initial vector is described.

One of known data cryptography systems is a block cipher. The block cipher is an example of common key ciphers in which the encryption key is the same as the decryption key.

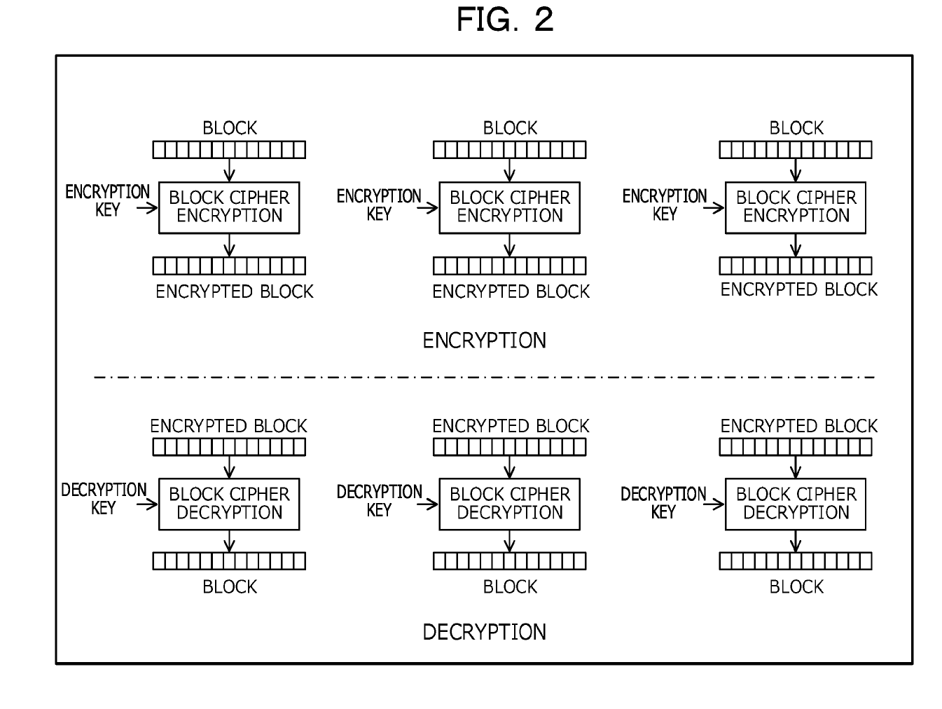

In an algorithm called the electronic codebook mode (ECB mode) among block cipher modes of operation, as illustrated in FIG. 2, a message is divided into blocks, and the blocks are then encrypted separately. The blocks that had been encrypted (hereinafter, referred to encrypted blocks) are individually decrypted.

With the ECB mode, identical data strings are encrypted into identical ciphertexts, which could place a threat to security in some cases. Accordingly, in other block ciphers, a random data string called an initial vector (hereinafter, also referred to as IV) is added to the first block or the like of plaintexts. Such block ciphers using the initial vector include the Cipher Block Chaining (CBC) mode, Propagating CBC (PCBC) mode, Cipher Feedback (CFB) mode, and Output Feedback (OFB) mode, for example.

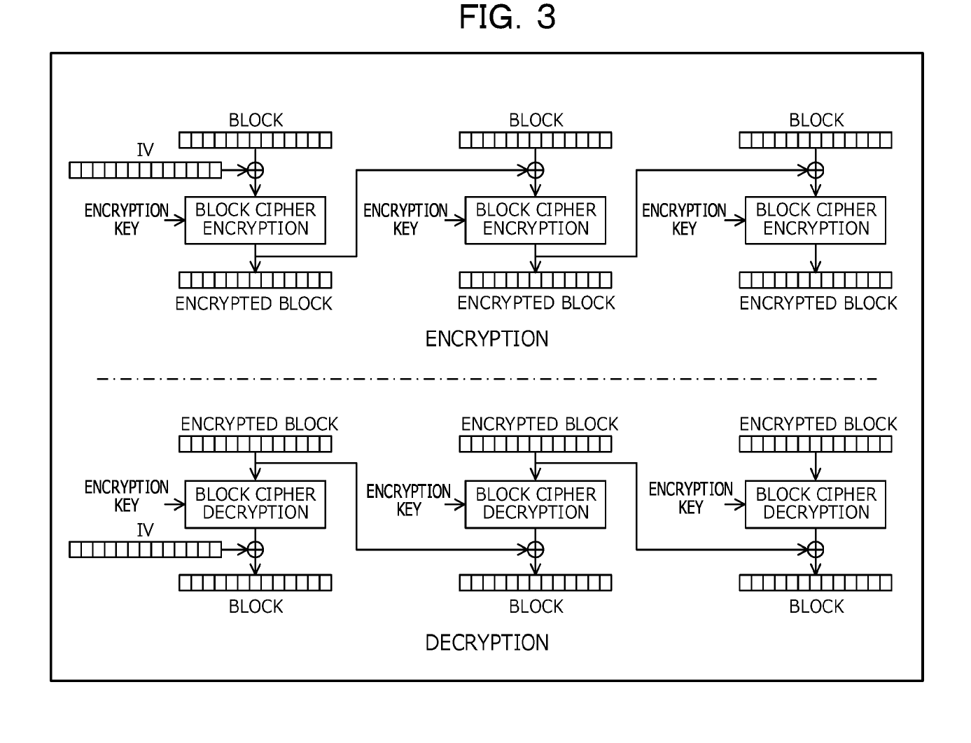

As an example, in the CBC mode, each block is XORed with the previous encrypted block and is then encrypted as illustrated in FIG. 3. Accordingly, each encrypted block depends on the previous blocks. The first block is XORed with the initial vector to be encrypted. In the decryption process, the result of decrypting each encrypted block is XORed with the previous encrypted block to provide the plaintexts of each block is obtained. The plaintexts of the first block are obtained by XORing the result of decrypting the first encrypted block with the initial vector.

In the following description, the cryptography system for files is a block cipher using an initial vector as an example.

The access permitting apparatus 3 is an example of a determination apparatus or an information processing apparatus which determines whether to permit an access to a file. The determination apparatus or information processing apparatus is one of various types of computers such as PCs and servers.

The accessing apparatus 4 is an example of the terminal which decrypts the encrypted file and is an example of an information processing apparatus used by the user to access the file. The information processing apparatus is one of various computers such as PCs, servers, personal digital assistants (PDAs), smart phones, and tablet terminals.

As illustrated in FIG. 1, the file management apparatus 2 transmits to the accessing apparatus 4, an encrypted file, a decryption key (a common key, for example), a condition type, and the value of F1.

The condition type is a type of condition set in the access permission condition, that is, an example of information representing what kind of information used in determination of the access permission condition. For example, the condition type may include at least one of position information, time information, the allowed number of accesses, the user ID, and the apparatus ID of the accessing apparatus 4.

The file management apparatus 2 may transmit the value of the F2 and the access permission condition (if set) to the access permitting apparatus 3.

The F1 and F2 are information obtained by decomposing the initial vector and are examples of first information and second information calculated from decryption information used to decrypt an encrypted file. The F1 and F2 may have the same data length as that of the initial vector. The F1 may be a random data string different from the initial vector, for example. The F2 may be generated based on at least one of the initial vector, F1, and access permission condition, for example. F2 may be an operation result of XORing the initial vector, F1, and access permission condition.

To view an encrypted file, the accessing apparatus 4 may transmit the F1 and the state information corresponding to the condition type to the access permitting apparatus 3 that stores F2. The state information is at least one of the current position information of the accessing apparatus 4, current time, the allowed number of accesses, the user ID, and the apparatus ID of the accessing apparatus 4, for example.

The access permitting apparatus 3 XORs the F1 and state information received from the accessing apparatus 4, the access permission condition, and the F2 corresponding to the F1 and transmits the operation result to the accessing apparatus 4. The accessing apparatus 4 may decrypt an encrypted file using the stored decryption key and the operation result received from the access permitting apparatus 3.

Herein, because of the nature of XOR, the result of the XOR operation for the value of F2 and the information used to calculate F2, other than the initial vector, coincides with the initial vector. Accordingly, when the accessing apparatus 4 satisfies the access permission condition, the operation result at the access permitting apparatus 3 coincides with the initial vector used to encrypt a file, and the accessing apparatus 4 decrypts the encrypted file correctly.

On the other hand, when the accessing apparatus 4 does not satisfy the access permission condition, the operation result is different from the initial vector, and the accessing apparatus 4 fails to decrypt the encrypted file. The F1 stored in the accessing apparatus 4 is a random data string different from the initial vector. Accordingly, the accessing apparatus 4 fails to decrypt the encrypted file correctly even using the decryption key and F1.

The F2 stored in the access permitting apparatus 3 is also a random data string different from the initial vector. Accordingly, the access permitting apparatus 3 fails to decrypt the encrypted file correctly even using F2.

The information processing system 1 according to the first embodiment distributes and manages the initial vector used in decryption. To take out the encrypted file to the accessing apparatus 4, the information processing system 1 permits the encrypted file to be decrypted and viewed when the previously specified condition is satisfied. In the information processing system 1, the encrypted file is not decrypted with only the information provided on the accessing apparatus 4 that tries to view the file, thus enhancing the security.

The information processing system 1 determines to permit or deny an access to a file by specifying one or multiple access permission conditions. Accordingly, even when the user has a malicious intent to unauthorizedly view the file or when the user loses the terminal, decryption key, or the like, decryption of the encrypted file fails unless the access permission condition is satisfied at decrypting the encryption file.

The information processing system 1 invalidates (deletes, for example) the F2 in the access permitting apparatus 3 after the terminal, decryption key, or the like is lost. The access permitting apparatus 3 therefore does not generate the correct initial vector even when the access permission condition is satisfied, so that decryption of the encrypted file fails.

As described above, according to the information processing system 1 of the first embodiment, it is possible to reduce the security risk concerning encrypted files.

Hereinafter, a description is given of a configuration example of each apparatus of the information processing system 1.

[1-2] Configuration Example of File Management Apparatus

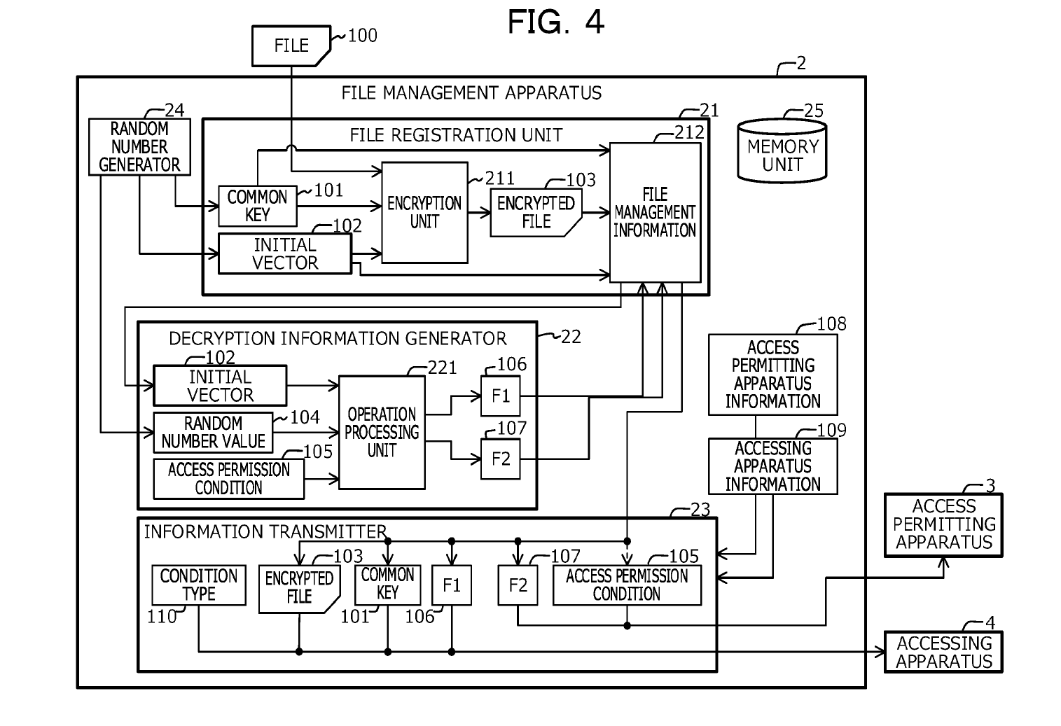

FIG. 4 is a diagram illustrating a functional configuration example of the file management apparatus 2. As illustrated in FIG. 4, the file management apparatus 2 may illustratively include a file registration unit 21, a decryption information generator 22, an information transmitter 23, a random number generator 24, and a memory unit 25.

The memory unit 25 stores information such as later-described various types of data used by the file management apparatus 2. The memory unit 25 may be implemented by a storage area of a volatile memory such as a random access memory (RAM), for example. The memory unit 25 may be implemented by a storage area of a non-volatile storage, for example. Examples of the non-volatile storage are magnetic disk devices such as hard disk drives (HDDs), semiconductor drive devices such as solid state drivers (SDDs), and non-volatile memories such as flash memories and read only memories (ROMs).

The random number generator 24 generates random numbers. Multiple different random numbers generated by the random number generator 24 may be individually used as a common key 101, an initial vector 102, and a random number value 104 as illustrated in FIG. 4. The common key 101, initial vector 102, and random number value 104 may be random numbers of an identical bit length.

The random number generator 24 may be one of various known configurations such as a hardware random number generator provided for or connected to the file management apparatus 2 and a software function to generate a random number (pseudorandom number).

The file registration unit 21 manages an inputted file 100. For example, when receiving a file 100, the file registration unit 21 generates an encryption key (a common key 101, for example) and an initial vector 102 for the file 100 and encrypts and manages the file 100. The file 100 is a document file, for example.

The file registration unit 21 may include an encryption unit 211. The encryption unit 211 may encrypt the inputted file 100 using the common key 101 and initial vector 102 inputted from the random number generator 24 to create an encrypted file 103. As the cryptography system, the encryption unit 211 may employ a block cipher. The block cipher may support the cipher mode using the initial vector.

The file registration unit 21 may register the common key 101, initial vector 102, and encrypted file 103 in file management information 212. The file 100 may be registered in the file management information 212. At least one of the file management information 212 and sets of information registered in the file management information 212 may be stored in the memory unit 25.

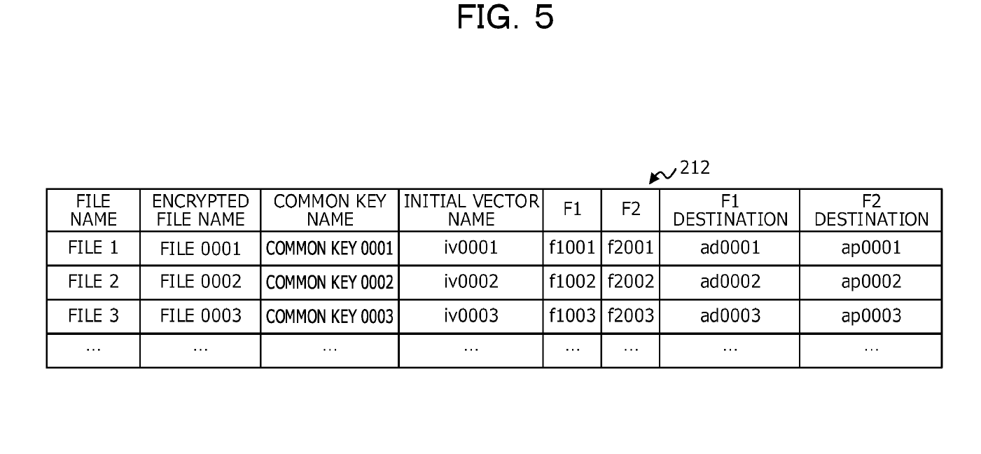

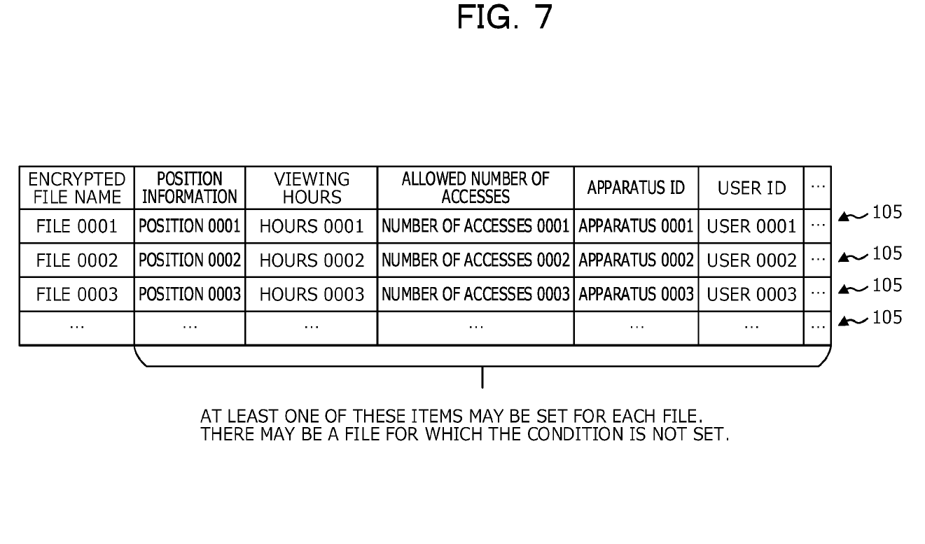

FIG. 5 illustrates an example of the file management information 212. The file management information 212 is an example of information used to manage a set of the encrypted file 103, common key 101, and initial vector 102. The file management information 212 may illustratively include items of “file name”, “encrypted file name”, “common key name”, “initial vector name”, “F1”, “F2”, “Fl destination”, and “F2 destination” as illustrated in FIG. 5. The file management information 212 may include information of an access permission condition 105 described later using FIG. 7.

The “file name” is an example of information specifying the file 100. The “encrypted file name” is information specifying the encrypted file 103 corresponding to the file 100. The “common key name” and “initial vector name” are examples of information specifying the encryption key and initial vector 102 used to encrypt the file 100, respectively.

The “F1” and “F2” are examples of information specifying F1 106 and F2 107 generated by a later-described decryption information generator 22. The “F1 destination” is an example of information specifying the accessing apparatus 4 to which the F1 106 is distributed. The “F2 destination” is an example of information specifying the access permitting apparatus 3 to which the F2 107 is distributed.

In the file management information 212, the aforementioned information may be set in association with the file 100. The file management information 212 may include the aforementioned information itself or may include the references (links, for example) to the aforementioned information stored in the memory unit 25.

The decryption information generator 22 generates the F1 106 and F2 107. The decryption information generator 22 may be provided with an operation processing unit 221.

The operation processing unit 221 may calculate the F1 106 and F2 107 based on the initial vector 102 managed by the file management information 212, the random number value 104 inputted from the random number generator 24, and the access permission condition 105 set for each file 100.

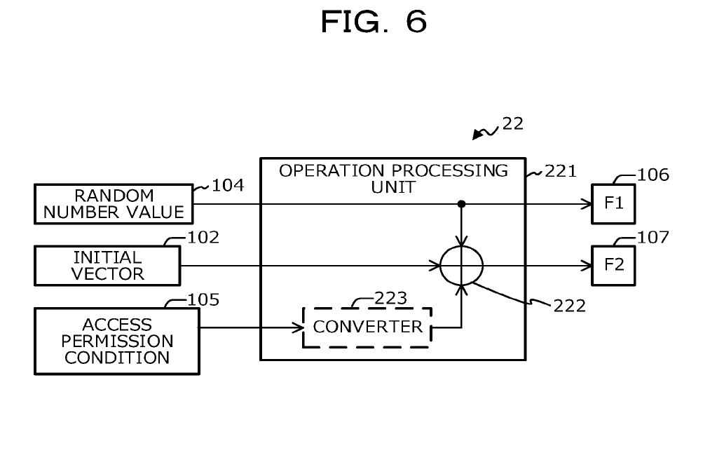

The operation processing unit 221 may be provided with an XOR operator 222 and a converter 223 as illustrated in FIG. 6. The operation processing unit 221 may output the random number value 104 as the F1 106 as illustrated in FIG. 6. The operation processing unit 221 may input the random number value 104, initial vector 102, and access permission condition 105 into the XOR operator 222. The XOR operator 222 may perform an XOR operation for these inputted values and output the operation result as the F2 107.

When the access permission condition 105 is information such as the “apparatus ID” or “user ID”, the operation processing unit 221 may directly input the access permission condition 105 into the XOR operator 222 without the conversion process by the converter 223. When the access permission condition 105 is another type of information, such as the “position information”, for example, the operation processing unit 221 may convert the access permission condition 105 into a form suitable for generating the F2 107 through the converter 223 and then input the converted access permission condition 105 into the XOR operator 222.

The converter 223 may convert the access permission condition 105 in accordance with the type of the access permission condition 105. The processing by the converter 223 is described later in detail.

As described above, the initial vector 102 is decomposed by the operation processing unit 221 into the F1 106 and F2 107. The F1 106, F2 107, and initial vector 102 have the following relationships.

F1=a random number value

F2=initial vector̂F1̂ access permission condition

initial vector=F1̂F2̂ access permission condition

(The symbol “̂” is an XOR operator. The same applies hereinafter.)

FIG. 7 illustrates examples of the access permission conditions 105. As illustrated in FIG. 7, each access permission condition 105 may include items such as “encrypted file name”, “position information”, “viewing hours”, “allowed number of accesses”, “apparatus ID”, and “user ID”.

FIG. 7 illustrates the access permission conditions 105 in a table form for convenience. The structure of the access permission conditions 105 is not limited to such a table form. The information of the access permission condition 105 may be stored in various forms in the memory unit 25 or the like. The same applies other later-described information illustrated in a table form.

The “encrypted file name” is an example of information specifying the encrypted file 103. The “position information” is information indicating the position or area (range) where viewing of the file 100 is permitted and may be at least a part of global positioning system (GPS) information, for example. The “viewing hours” is information indicating the time period when viewing of the file 100 is permitted. The “allowed number of accesses” is information indicating the number of times that the encrypted file 103 is permitted to be accessed (the number of times that the file 100 is viewed, for example). The “apparatus ID” and “user ID” are examples of information respectively specifying the accessing apparatus 4 and user which are permitted to view the file 100.

The “position information” of the access permission condition 105 may be information on the position or the central coordinates of the area where viewing of the file 100 is permitted, for example. An example thereof is information of the position of the access permitting apparatus 3.

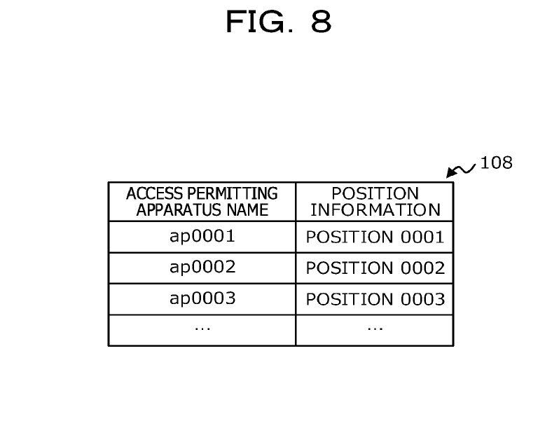

FIG. 8 illustrates an example of access permitting apparatus information 108. As illustrated in FIG. 8, the access permitting apparatus information 108 may include an “access permitting apparatus name” as an example of the place where decryption of the encrypted file 103 is permitted and “position information” of the access permitting apparatus 3.

The position information in the access permission condition 105 may be the position information of the access permitting apparatus 3 in the access permitting apparatus information 108, an index of the corresponding entry in the access permitting apparatus information 108, or a link to the “access permitting apparatus name”. Alternatively, the access permission condition 105 may not include an item of the “position information”, and the access permitting apparatus information 108 may be used instead.

The access permission condition 105 does not have to include an item of the “user ID”, and accessing apparatus information 109 may be used instead.

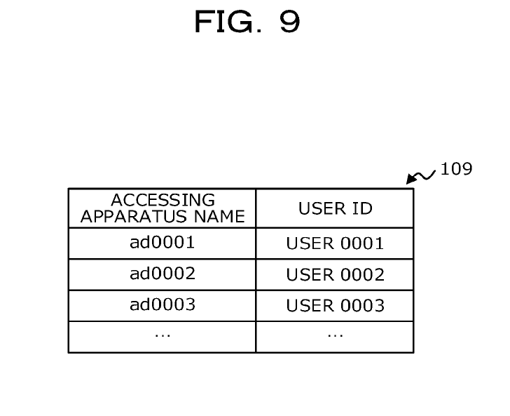

FIG. 9 illustrates an example of the accessing apparatus information 109. As illustrated in FIG. 9, the accessing apparatus information 109 may include an “accessing apparatus name” used by a user who is permitted to decrypt the encrypted file 103 and the “user ID” as an example of the identification information of the user.

The “user ID” in the access permission condition 105 may be the index of the corresponding entry in the accessing apparatus information 109 or a link to the “accessing apparatus name”.

In a similar manner, each of the “viewing hours”, “allowed number of accesses”, and “apparatus ID”, may be managed by another type of information in addition to or instead of the access permission condition 105.

In the access permission condition 105, at least one of the aforementioned items may be set as the condition for each file 100 (each encrypted file 103, for example) by the operator of the file management apparatus 2 and may be stored in the memory unit 25 or the like. There may be a file 100 for which the access permission condition 105 is not set.

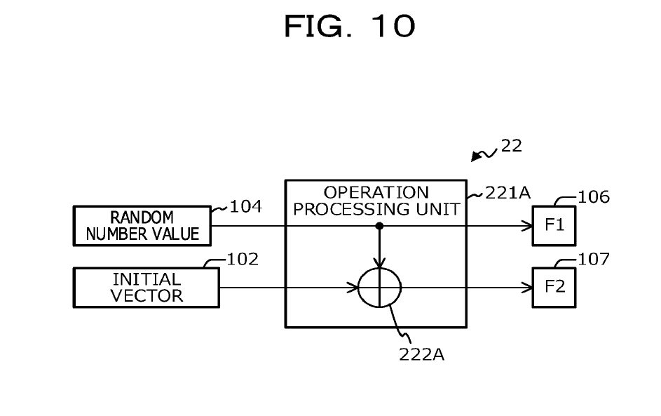

When the access permission condition 105 is not set for a file 100, the operation processing unit 221 may be configured or function as an operation processing unit 221A illustrated in FIG. 10. As illustrated in FIG. 10, the operation processing unit 221A may include an XOR operator 222A which performs an XOR operation for the random number value 104 and initial vector 102 as the inputs and outputs the operation result as the F2 107. The F2 107 may be acquired by the XOR operation for the random number value 104 (or the F1 106) and the initial vector 102. The operation processing unit 221A illustrated in FIG. 10 is described above as the configuration example where the access permission condition 105 is not set. However, the configuration is not limited to this. For example, in the operation processing unit 221 illustrated FIG. 6, the converter 223 may be configured or function to output all the bits set to 0 when the access permission condition 105 is not set, so that the operation processing units 221 and 221A may be commonalized.

The XOR operator 222 or 222A may be one of various known configurations such as hardware XOR operators and software XOR operation functions.

The operation processing unit 221 may register the F1 106 and F2 107 in the file management information 212. At least one of the F1 106 and F2 107 may be stored in the memory unit 25.

The aforementioned setting process for the access permission condition 105 and the process by the decryption information generator 22 may be carried out upon reception of a request to distribute a file 100 from the accessing apparatus 4 in the light of the possibility of the access permission condition 105 being changed before the encrypted file 103 is distributed, for example. Alternatively, the above processes may be carried out in parallel to the process to register the file 100 by the file registration unit 21 or after the registration process when the access permission condition 105 is less likely to be changed or is not set.

As described above, the decryption information generator 22 is an example of an operator calculating first information and second information from decryption information used to decrypt an encrypted file. The decryption information may include at least one of the common key 101 and initial vector 102. The first information and second information may include the F1 106 and F2 107, respectively.

The information transmitter 23 transmits information used in a process concerning viewing of a file 100 to the accessing apparatus 4 and access permitting apparatus 3. The process of the information transmitter 23 may be carried out upon reception of the request to distribute the file 100 from the accessing apparatus 4.

The information transmitter 23 may acquire various types of information associated with the file 100 requested by the accessing apparatus 4 to be viewed, with reference to the file management information 212, as information to be transmitted to the accessing apparatus 4 and access permitting apparatus 3, for example. At least part of the information may be acquired from the memory unit 25.

As an example, as the information to be transmitted to the accessing apparatus 4, the information transmitter 23 may acquire the encrypted file 103, common key 101, F1 106, and information of the corresponding entry of a condition type 110 if set and transmit the acquired information to the accessing apparatus 4.

The information transmitter 23 may also acquire the F2 107 and information of the corresponding entry of the access permission condition 105 as the information to be transmitted to the access permitting apparatus 3 which determines whether to permit the accessing apparatus 4 to access the file 100 and transmit the same to the access permitting apparatus 3.

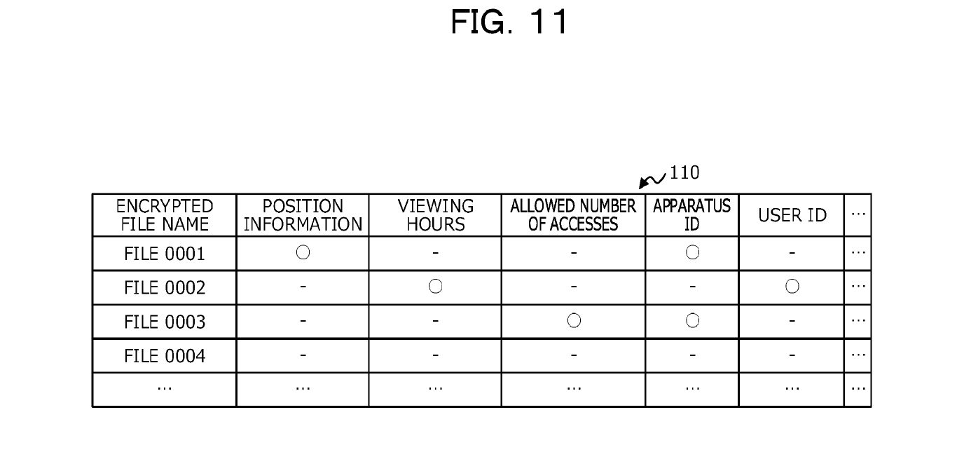

FIG. 11 illustrates an example of the condition type 110. The condition type 110 may illustratively include the same items as those of the access permission condition 105 as illustrated in FIG. 11. The condition type 110 may be properly updated as the access permission condition 105 is updated.

The condition type 110 may include, for each encrypted file 103, information specifying whether to use each item to determine access permissions for the encrypted file 103 (whether the item is valid, for example). In the example of FIG. 11, valid items are set to “o” while invalid items are set to “−”.

Alternatively, in the condition type 110, only items used to determine access permissions among the items of the access permission condition 105 may be set for each encrypted file 103. The information transmitter 23 may notify the accessing apparatus 4 of information indicating the item used to determine access permissions from the access permission condition 105 without providing the condition type 110.

The information transmitter 23 is an example of a transmitter which transmits the first information to the accessing apparatus 4 and transmits the second information to the access permitting apparatus 3 as described above.

In the file management apparatus 2, the access permission condition 105 relating to the accessing apparatus 4 which has received the distributed encrypted file 103 is updated by addition, changing, deletion, or the like in some cases.

In this case, the file management apparatus 2 may change the access permission condition 105 without changing the values of the random number value 104 (F1 106) and initial vector 102 to generate a new F2 107 through the operation processing unit 221. The file management apparatus 2 may notify the access permitting apparatus 3 of the newly generated F2 107 and notify the accessing apparatus 4 of the updated condition type 110.

Even when the access permission condition 105 is changed, the access permission condition 105 is flexibly and easily changed without changing the information including the encrypted file 103, common key 101, and F1 106 transmitted to the accessing apparatus 4.

To prohibit or stop viewing of a file 100, the file management apparatus 2 may invalidate the F2 107 for the file 100. The way of invalidating the F2 107 is one of various methods such as deleting the F2 107, setting all the bits of the F2 107 to “0” or setting the F2 107 to an incorrect value, and managing a flag indicating that the F2 107 is invalid and setting the flag to “invalid”. The information of the invalid F2 107 may be transmitted to the access permitting apparatus 3.

When the user loses the accessing apparatus 4, common key 101, or the like or leaves the job, the file management apparatus 2 has only to invalidate the F2 107 in the access permitting apparatus 3. Since the F2 107 is invalid, the access permitting apparatus 3 is incapable of correctly generating the initial vector 102 even when the access permission condition 105 is satisfied. This makes it impossible to decrypt the encrypted file 103, thus reducing the security risk, that is, a risk of data leakage, for example.

[1-3] Configuration Example of Access Permitting Apparatus

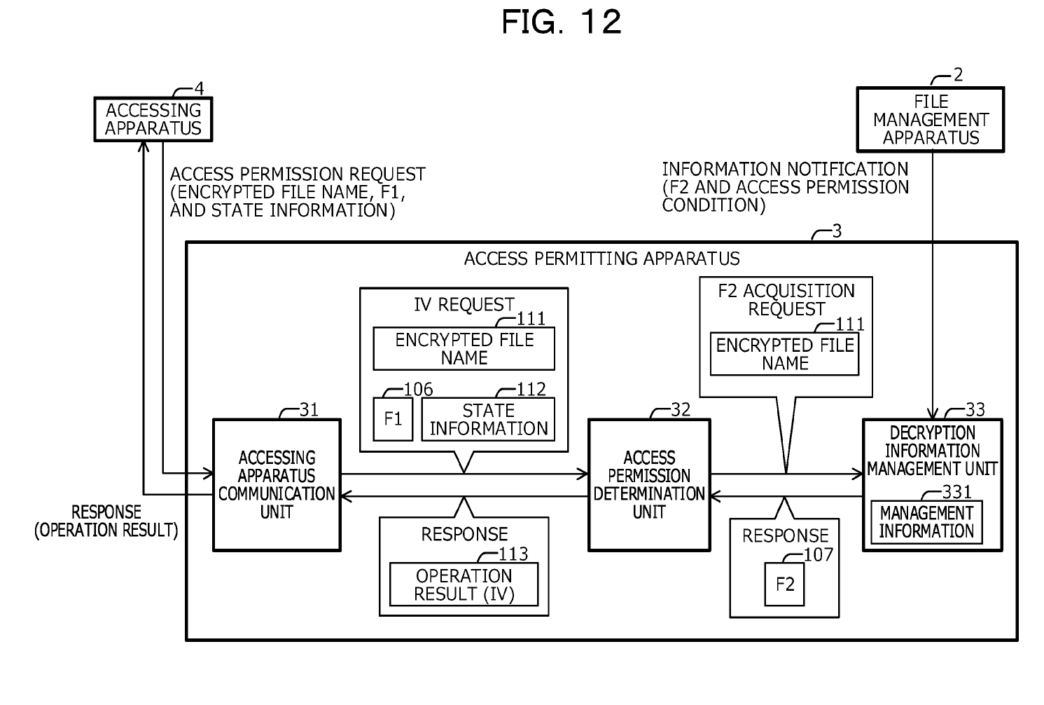

FIG. 12 is a diagram illustrating a functional configuration example of the access permitting apparatus 3. As illustrated in FIG. 12, the access permitting apparatus 3 may illustratively include an accessing apparatus communication unit 31, an access permission determination unit 32, and a decryption information management unit 33.

The access permitting apparatus 3 may be provided with a memory unit (not illustrated) implemented by a storage region of the memory provided for the access permitting apparatus 3. The memory unit may store at least one of the F1 106, the F2 107, an encrypted file name 111, state information 112, an operation result 113, and management information 331.

The accessing apparatus communication unit 31 communicates with the accessing apparatus 4. The accessing apparatus communication unit 31 may receive a request to permit access from the accessing apparatus 4 and request the initial vector 102 from the access permission determination unit 32, for example.

The accessing apparatus communication unit 31 may transmit to the accessing apparatus 4, the operation result 113 for the initial vector 102 inputted from the access permission determination unit 32 as the response to the request to permit access. In other words, the accessing apparatus communication unit 31 is an example of a notification unit which notifies the accessing apparatus 4 of the generated initial vector 102.

Upon receiving the request to permit access, the accessing apparatus communication unit 31 may request and acquire the encrypted file name 111 to be decrypted in the accessing apparatus 4, the F1 106 for the encrypted file, and the state information 112 of the accessing apparatus 4 from the accessing apparatus 4. Alternatively, the above information may be included in the request to permit access.

The access permission determination unit 32 determines whether to permit the accessing apparatus 4 to access the encrypted file 103, based on the information inputted from the accessing apparatus communication unit 31.

For example, the access permission determination unit 32 may put the encrypted file name 111 received from the accessing apparatus communication unit 31, into the request to acquire the F2 107 which is to be transmitted to the decryption information management unit 33. The access permission determination unit 32 may calculate the operation result 113 based on the F2 107 included in the response from the decryption information management unit 33 and the F1 106 and state information 112 received from the accessing apparatus communication unit 31. The access permission determination unit 32 may transmit the request including the operation result 113 to the accessing apparatus communication unit 31.

As described above, when the accessing apparatus 4 does not satisfy the access permission condition 105, decryption of the encrypted file 103 using the operation result 113 generated in the access permitting apparatus 3 fails. The access permission determination unit 32 therefore provides the result of determining whether to permit access based on whether the operation result 113 coincides with the correct initial vector 102.

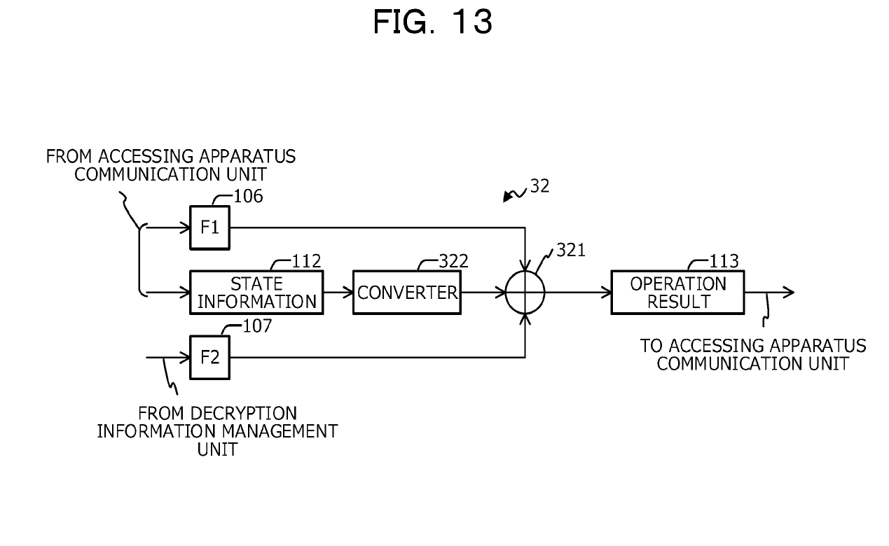

The access permission determination unit 32 may include an XOR operator 321 and a converter 322 as illustrated in FIG. 13. The access permission determination unit 32 inputs the F1 106, F2 107, and state information 112 into the XOR operator 321. The XOR operator 321 may perform an XOR operation for these inputted values and output the operation result 113 from the XOR operation.

The access permission determination unit 32 may directly input the state information 112 into the XOR operator 321 without a conversion process in the converter 322 when the state information 112 is information such as the apparatus ID or user ID. When the state information 112 is another type of information such as “position information”, the access permission determination unit 32 may convert the state information 112 with the converter 322 into a form suitable for determination based on the access permission condition 105 and then input the converted state information 112 into the XOR operator 321.

The converter 322 may convert the state information 112 in accordance with the access permission condition 105 inputted from the file management apparatus 2. The process in the converter 322 is described in detail later.

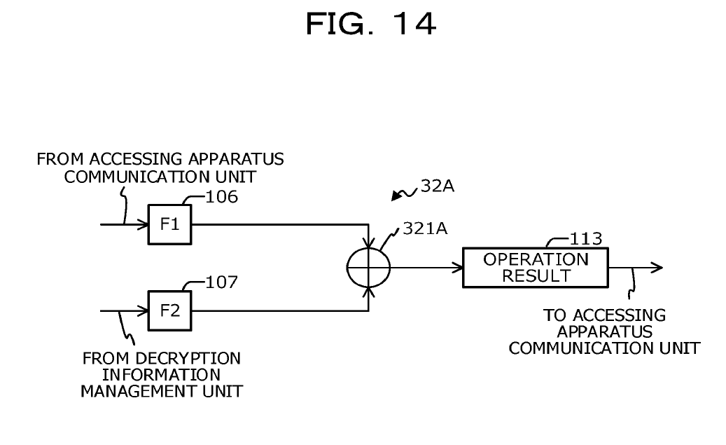

When the access permission condition 105 is not set for the encrypted file 103, the access permission determination unit 32 may be configured or caused to function as an access permission determination unit 32A illustrated in FIG. 14. As illustrated in FIG. 14, the access permission determination unit 32A may perform an XOR operation for the values of the F1 106 and F2 107 as the inputs and output the operation result 113 of the XOR operation. The operation result 113 may be acquired by an XOR operation for the F1 106 and F2 107. As the configuration example where the access permission condition 105 is not set, the access permission determination unit 32A illustrated in FIG. 14 is described. However, the configuration is not limited to this. For example, in the access permission determination unit 32 illustrated in FIG. 13, the converter 322 may be configured or function to output 0 when the access permission condition 105 is not set, so that the access permission determination units 32 and 32A are commonalized.

The XOR operator 321 or 321A may be one of various known configurations such as hardware XOR operators and software XOR operation functions.

The access permitting apparatus 3 may receive information of the initial vector 102 from the file management apparatus 2 and store the received information in the memory unit, for example. In this case, the access permission determination unit 32 may compare the generated operation result 113 with the stored initial vector 102. When the operation result 113 coincides with the initial vector 102, the access permission determination unit 32 may respond the operation result 113, and otherwise, the access permission determination unit 32 may respond access denied.

The access permitting apparatus 3 may receive a result (successful or unsuccessful decryption, for example) of decryption using the operation result 113 from the accessing apparatus 4. In this case, the access permission determination unit 32 may respond access denied when the operation result 113 generated for the same encrypted file 103 or F1 106 is different from the operation result 113 obtained when decryption is successful.

The access permitting apparatus 3 may respond access denied when the F2 107 is not received from the decryption information management unit 33, such as when the F2 107 is deleted, for example.

With any method described above, the accessing apparatus 4 is notified of access denied when decryption fails. Accordingly, the accessing apparatus 4 does not have to perform decryption that may not be performed, using the operation result 113 with which decryption fails, thus reducing an increase in processing load.

The access permission determination unit 32 is an example of a determination unit that determines whether to permit decryption of the encrypted file 103. The access permission determination unit 32 is an example of a generator which acquires the F1 106 from the accessing apparatus 4 and, when decryption of the encrypted file 103 is permitted, generates the initial vector 102 based on the F1 106, F2 107, and access permission condition 105. The case where the encrypted file 103 is capable of being decrypted includes the case where the state information 112 satisfies the access permission condition 105 at decryption of the encrypted file 103.

The encryption information management unit 33 is an example of a management unit that manages the F2 107. The decryption information management unit 33 responds the F2 107, which corresponds to the encrypted file name 111 inputted from the access permission determination unit 32, to the access permission determination unit 32. The decryption information management unit 33 may illustratively include the management information 331.

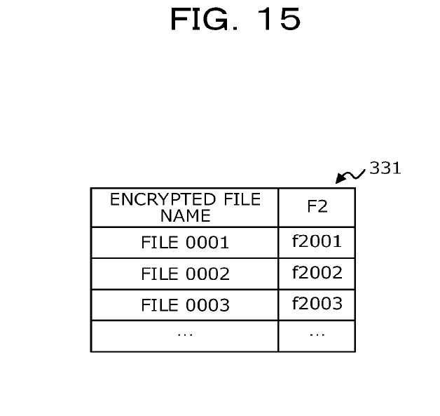

FIG. 15 illustrates an example of the management information 331. As illustrated in FIG. 15, the management information 331 may include the “encrypted file name” and the “F2” corresponding thereto. When the information on the F2 107 is received from the file management apparatus 2, the management information 331 may be updated using the received information.

The information on the F2 107 received from the file management apparatus 2 includes information representing registration, updating, invalidation, or the like of the F2 107.

[1-4] Configuration Example of Accessing apparatus

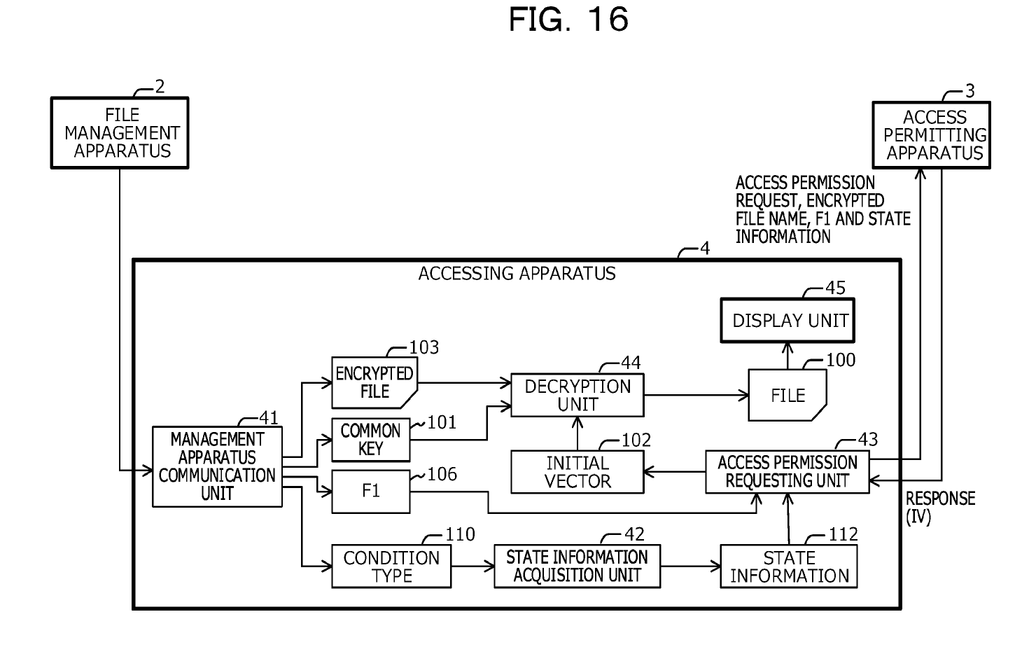

FIG. 16 is a diagram illustrating a functional configuration example of the accessing apparatus 4. As illustrated in FIG. 16, the accessing apparatus 4 may illustratively include a management apparatus communication unit 41, a state information acquisition unit 42, an access permission requesting unit 43, a decryption unit 44, and a display unit 45.

The accessing apparatus 4 may include a memory unit (not illustrated) implemented by a storage region of a memory provided for the accessing apparatus 4. The memory unit may store at least one of the file 100, common key 101, initial vector 102, encrypted file 103, F1 106, condition type 110, and state information 112, which are described later.

The management apparatus communication unit 41 communicates with the file management apparatus 2. The management apparatus communication unit 41 may receive the encrypted file 103, common key 101, F1 106, and condition type 110 from the file management apparatus 2 and store the same in the memory unit.

When the user requests to view the encrypted file 103, for example, the state information acquisition unit 42 acquires the state information 112 of the accessing apparatus 4 corresponding to the condition type 110 received from the file management apparatus 2 and outputs the acquired state information 112 to the access permission requesting unit 43.

When the condition type 110 is “position information”, for example, the state information acquisition unit 42 may acquire the position information of the accessing apparatus 4 as the state information 112 from a device which is provided for the accessing apparatus 4 and is configured to acquire the position information, such as a GPS device, for example.

When the condition type 110 is “viewing hours”, for example, the state information acquisition unit 42 may acquire information on the current time as the state information 112 from the function of managing time information. The state information acquisition unit 42 may acquire the information on the current time from an external device such as a network time protocol (NTP) server, for example.

When the condition type 110 is “the allowed number of accesses”, the state information acquisition unit 42 may acquire as the state information 112, the number of accesses to the same encrypted file 103, such as the number of times that the request to access is transmitted or the number of times that the encrypted file 103 is tried to be decrypted, for example.

When the condition type 110 is the “apparatus ID” or “user ID”, the state information acquisition unit 42 may acquire as the state information 112, the apparatus or user ID from the function of managing the “apparatus ID” or “user ID”.

When the condition type 110 includes multiple conditions, the state information acquisition unit 42 may acquire multiple conditions as the state information 112. When the condition type 110 is not received, such as when the access permission condition 105 is not set, for example, the state information acquisition unit 42 may notify the access permission requesting unit 43 that the access permission condition 105 is not set or the state information 112 is not to be outputted.

The access permission requesting unit 43 transmits an access permission request to the access permitting apparatus 3 and acquires the initial vector 102 from the response received from the access permitting apparatus 3.

After transmitting the access permission request, the access permission requesting unit 43 may transmit the F1 106, state information 112, and encrypted file name 111 to the access permitting apparatus 3 in response to the request from the access permitting apparatus 3. Alternatively, the access permission requesting unit 43 may put the above information in the access permission request which is to be transmitted.

As described above, the access permission requesting unit 43 is an example of a notification unit which notifies the access permitting apparatus 3 including the F2 107 of the F1 106 at decryption of the encrypted file 103. The access permission requesting unit 43 is also an example of an acquisition unit which acquires the initial vector 102 generated based on the F1 106 and F2 107, from the access permitting apparatus 3 when decryption of the encrypted file 103 is permitted.

The decryption unit 44 decrypts the encrypted file 103 using the common key 101 and the initial vector 102 acquired by the access permission requesting unit 43 to acquire the file 100. The decryption unit 44 may employ a decryption method corresponding to the encryption unit 211 of the file management apparatus 2, such as a block cipher, for example. The block cipher may support the cipher mode using an initial vector, for example.

The display unit 45 is one of various types of devices which display the contents of the file 100 to the user. As an example, the display unit 45 may include one or both of a display and a printer.

After receiving the initial vector 102 from the access permitting apparatus 3, the access permission requesting unit 43 may request the initial vector 102 from the access permitting apparatus 3 at regular time intervals while the encrypted file 103 is decrypted into the file 100 and the file 100 is used. When the initial vector 102 received first from the access permitting apparatus 3 is different from the initial vector 102 with which the encrypted file 103 has been successfully decrypted before, the accessing apparatus 4 may stop to use the file 100, by closing the file 100, for example.

The requests at regular time intervals may be transmitted to the access permitting apparatus 3 separately from access permission requests (as regular confirmation requests, for example). When the access permission condition 105 includes the “allowed number of accesses”, the number of regular confirmation requests may not be counted in the number of accesses from the accessing apparatus 4.

When it is found by such regular confirmation that the access permission condition 105 is not satisfied after the encrypted file 103 is successfully decrypted, such as when the accessing apparatus 4 leaves from the position where viewing is permitted, with the file 100 being opened, for example, the access to the file 100 is disabled. This reduces the risk of information leakage.

[1-5] Configuration Example of Converter Corresponding to Type of Access Permission Condition

Next, a description is given of a configuration example of the converter 223 provided for the operation processing unit 221 of the file management apparatus 2 and a configuration example of the converter 322 provided for the access permission determination unit 32 of the access permitting apparatus 3 for each type of the access permission condition.

[1-5-1] Case where Access Permission Condition is Position Information (First Example)

(Configuration Example of Converter 223)

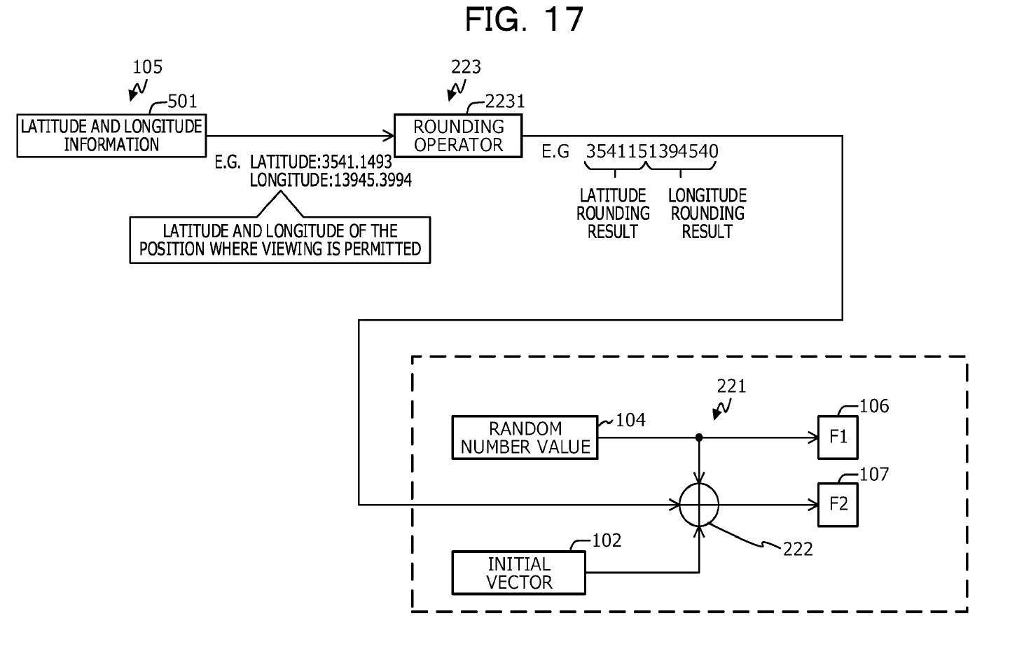

As illustrated in FIG. 17, the converter 223 of the file management apparatus 2 may include a rounding operator 2231.

When the access permission condition 105 includes the “position information”, for example, the “position information” may be the position where viewing of the file 100 is permitted, such as latitude and longitude information 501 of the access permitting apparatus 3, for example. The latitude and longitude information 501 calculated based on information from the GPS may be represented as “latitude: 3541.1493 (35 degrees and 41.1493 minutes)”, “longitude: 13945.3994 (139 degrees and 45.3994 minutes)”, and the like.

The rounding operator 2231 may perform a rounding operation for the latitude and longitude information 501 and expand the position where viewing of the file 100 is permitted to an area (range) including the position. The degree of accuracy with which the latitude and longitude information 501 is rounded may be determined by an operator or the like, for example. The size of the area where the accessing apparatus 4 is permitted to view the file 100 depends on the accuracy of the rounding operation. The accuracy of the rounding operation may be determined for each file 100.

As an example, the process of the rounding operator 2231 for the latitude and longitude information 501 of latitude: 3541.1493 and longitude: 13945.3994 is described. The rounding operator 2231 rounds off the minutes of the latitude and longitude of the latitude and longitude information 501 to two decimal places, for example and connects the rounded values of the latitude and longitude to provide “3541151394540” as the operation result. The obtained operation result is outputted to the XOR operator 222 (see FIG. 6). The rounding operator 2231 performs a rounding process such as round-down or round-up operation instead of round-off operation.

The XOR operator 222 may calculate the F2 107 as follows using the result of rounding operation for the latitude and longitude information 501.

F2=F1̂IV̂ [Result of rounding operation for latitude and longitude information]

(Configuration Example of Converter 322)

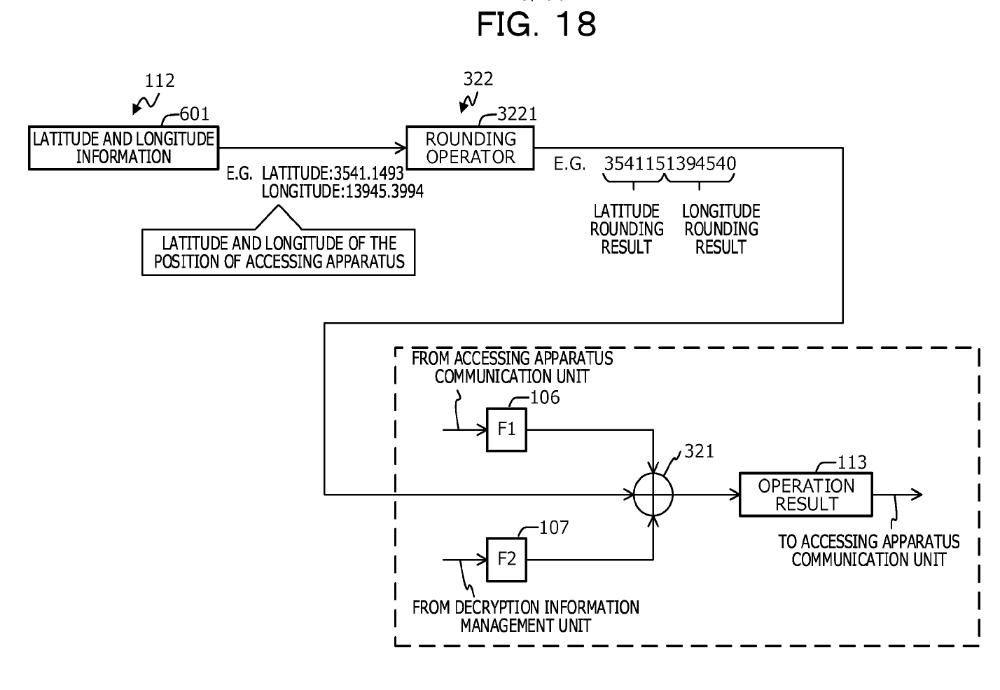

As illustrated in FIG. 18, the converter 322 of the access permission determination unit 32 may be provided with a rounding operator 3221.

When the state information 112 inputted from the accessing apparatus 4 includes the “position information”, for example, the “position information” may be latitude and longitude information 601 of the current position of the accessing apparatus 4, for example.

The rounding operator 3221 may perform a rounding operation for the latitude and longitude information 601 and expand the position where viewing of the file 100 is permitted to an area (range) including the position. The degree of accuracy of the rounding operation and the type of rounding process (round-off or the like) in the rounding operation 3221 may be the same as those of the rounding operator 2231 of the file management apparatus 2.

The latitude and longitude information 601 may be converted to information of the area including the current position of the accessing apparatus 4 by the rounding operator 3221 in a similar manner to the rounding operator 2231.

The XOR operator 321 may calculate the operation result 113, such as the initial vector 102, for example, as follows using the result of rounding operation for the latitude and longitude information 601.

IV=F1̂F2̂ [Result of rounding operation for latitude and longitude information]

When the operation result from the rounding operator 3221 coincides with the operation result from the rounding operator 2231, in other words, when the area of the accessing apparatus 4 coincides with the area where viewing of the file 100 is permitted, the operation result 113 which coincides with the correct initial vector 102 is obtained.

[1-5-2] Case where Access Permission Condition is Position Information (Second Example)

(Configuration Example of Converter 223)

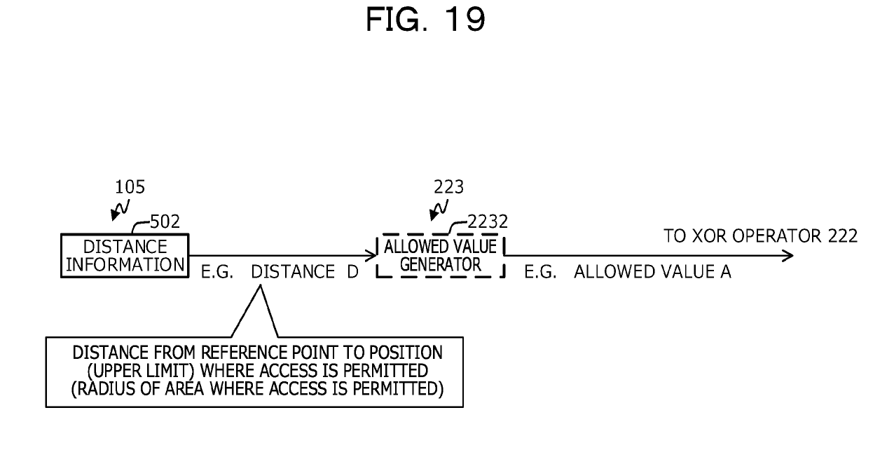

As illustrated in FIG. 19, the converter 223 of the file management apparatus 2 may include an allowed value generator 2232. In FIG. 19, information outputted from the converter 223 may be inputted to the XOR operator 222 together with the random number value 104 and initial vector 102 in a similar manner to FIG. 17. In the following description, the operation processing unit 221 and the like are not illustrated for simplification of the drawing.

When the access permission condition 105 includes “position information”, the “position information” may be distance information 502 representing the distance from the reference position, such as the position of the access permitting apparatus 3, for example, to the position (the upper limit position) where viewing of the file 100 is permitted. In other words, the distance information 502 may be characterized as the radius of the area where viewing of the file 100 is permitted.

The distance information 502, such as distance D, for example, may be determined by an operator or the like. The size of the area where the accessing apparatus 4 is permitted to view the file 100 depends on the value of the distance D. The value of the distance D may be determined for each file 100.

The allowed value generator 2232 generates the allowed value, such as an allowed value A, for example, and outputs the same to the XOR operator 222. The converter 223 may determine whether the allowed value A depending on the presence of the distance information 502. The value of the distance D does not have to be used to generate the allowed value A.

The XOR operator 222 may calculate the F2 107 using the allowed value A as follows.

F2=F1̂IV̂ [Allowed value A]

(Configuration Example of Converter 322)

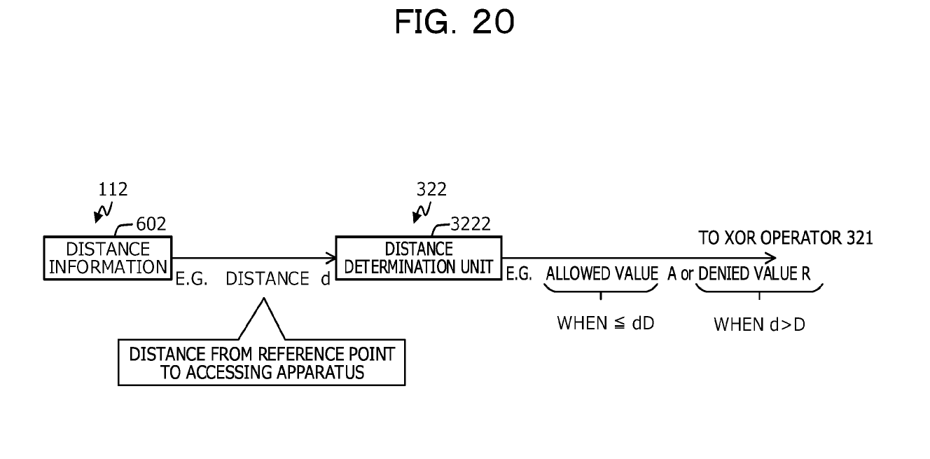

As illustrated in FIG. 20, the converter 322 of the access permission determination unit 32 may include a distance determination unit 3222. In FIG. 20, information outputted from the converter 322 may be inputted to the XOR operator 321 together with the F1 106 and F2 107 in a similar manner to FIG. 18. In the following description, the XOR operator 321 and the like are not illustrated for simplification of the drawing.

When the state information 112 inputted from the accessing apparatus 4 includes “position information”, the “position information” may be distance information 602 representing the distance from the reference position, such as the position of the access permitting apparatus 3, for example, to the current position of the accessing apparatus 4.

The distance determination unit 3222 compares the distance information 602, such as distance d, for example, with the distance D in the access permission condition 105 received from the file management apparatus 2. When the distance d is not more than the distance D, the distance determination unit 3222 may generate the allowed value A and output the same to the XOR operator 321. When the distance d is more than the distance D, the distance determination unit 3222 may generate a denied value R, which is different from the allowed value A, and output the same to the XOR operator 321.

The distance D and allowed value A used in determination by the distance determination unit 3222 may be the same as those used in description of the allowed value generator 2232.

The distance determination unit 3222 may determine whether the current distance d between the reference point and accessing apparatus 4 is not more than the distance D for access permission between the reference point and the accessing apparatus 4 which is previously determined by the file management apparatus 2.

The XOR operator 321 may calculate the operation result 113 using the determination result by the distance information 602 as follows.

IV=F1̂F2̂ [Allowed value A or denied value R]

When the determination result by the distance determination unit 3222 coincides with the output result from the allowed value generator 2232, in other words, when the accessing apparatus 4 is located within the distance D where viewing of the file 100 is permitted, the obtained operation result 113 coincides with the correct initial vector 102.

The “position information” included in the state information 112 is the latitude and longitude information 601 illustrated in FIG. 18, the process by the distance determination unit 3222 may be performed. In this case, the converter 322 may calculate as the distance d, the distance between the reference point and the accessing apparatus 4 based on the latitude and longitude information of the access permitting apparatus 3, for example, and the latitude and longitude information 601 of the accessing apparatus 4 and use the calculated distance d for determination by the distance determination unit 3222.

[1-5-3] Case where Access Permission Condition is Viewing Hours

(Configuration Example of Converter 223)

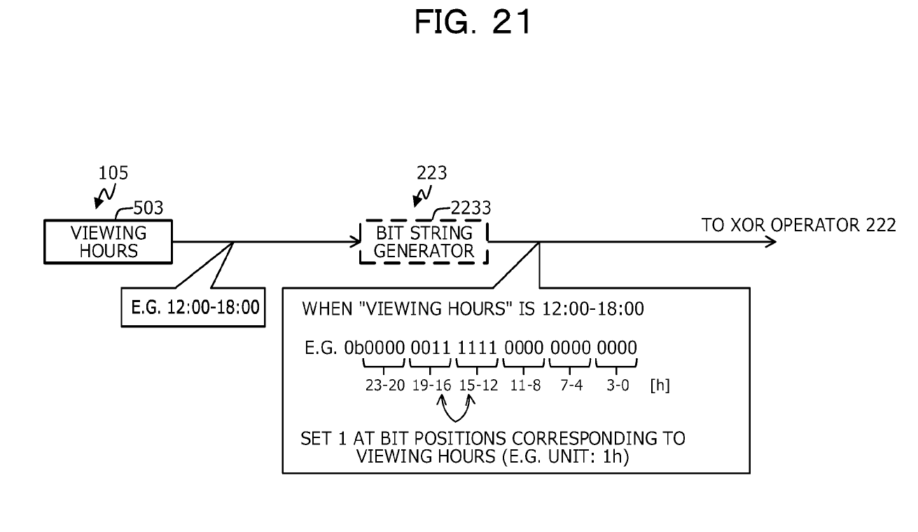

As illustrated in FIG. 21, the converter 223 of the file management apparatus 2 may include a bit string generator 2233.

When the access permission condition 105 includes viewing hours 503, the viewing hours 503 may be specified on an hourly basis (from 0 to 23), for example.

The bit string generator 2233 converts the inputted viewing hours 503 into a bit string that represents the time on an hourly basis in bits and outputs the obtained bit string to the XOR operator 222.

As an example, when the viewing hours 503 are 12-18 (12:00-17:59, for example), the bit string generator 2233 may generate the following bit string. The following string includes 24 bits corresponding to respective hours. The least and most significant bits thereof correspond to 0 and 23, respectively. In this string, bits corresponding to hours when viewing is permitted are set to 1, and bits corresponding to hours when viewing is not permitted are set to 0.

Bit string representing viewing hours of “12-18”: “0b0000 0011 1111 0000 0000 0000”

The XOR operator 222 may calculate the F2 107 using the bit string indicating the viewing hours as follows.

F2=F1̂IV̂ [Bit string representing viewing hours]

The bit string indicating the viewing hours may be set in the “viewing hours” in the access permission condition 105. In this case, the bit string generator 2233 does not have to be provided in the converter 223.

Instead of on an hourly basis, the viewing hours 503 may be on a minute basis, a second basis, or a daily basis or a combination thereof.

To notify the access permitting apparatus 3 of the access permission condition 105, the file management apparatus 2 may notify the access permitting apparatus 3 of the aforementioned bit string as the information of the “viewing hours”.

(Configuration Example of Converter 322)

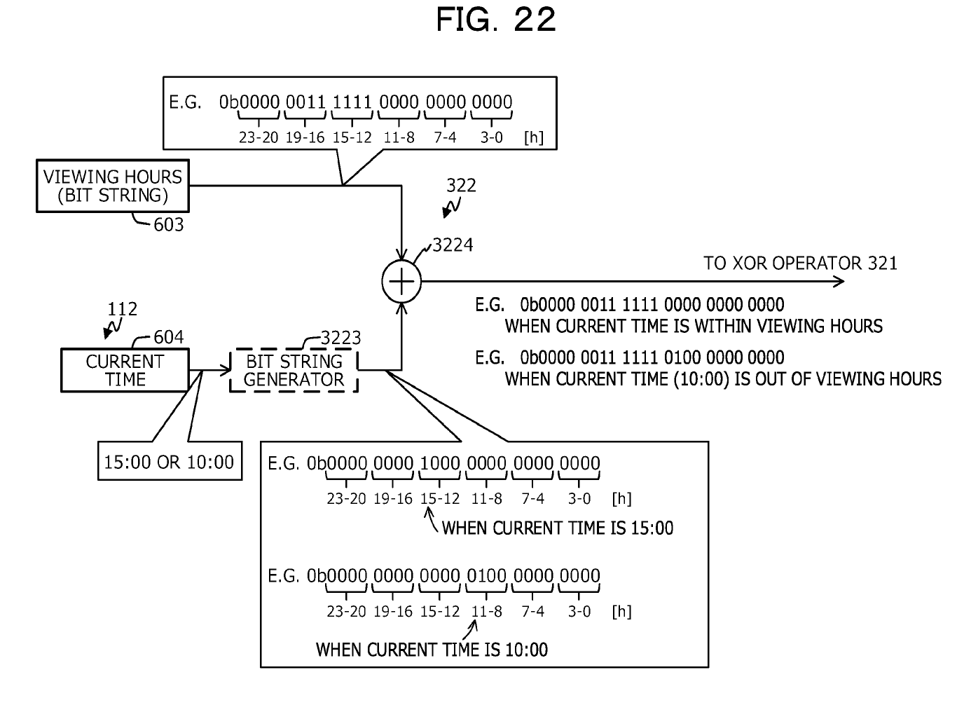

As illustrated in FIG. 22, the converter 322 of the access permission determination unit 32 may include a bit string generator 3223 and an OR operator 3224.

When the state information 112 inputted from the accessing apparatus 4 includes current time 604, the bit string generator 3223 may generate a bit string from the current time 604 in the same manner as the bit string generator 2233 of the file management apparatus 2 and output the same to the OR operator 3224.

When the bit string generator 2233 generates an hourly-based bit string, the bit string generator 3223 generates a hourly-based bit string representing the current time 604, for example.

As an example, the current time 604 is 15:00 or 10:00, the bit string generator 3223 may generate the following bit strings.

Bit string representing current time of “15:00”:

“0b0000 0000 1000 0000 0000 0000”

Bit string representing current time of “10:00”:

“0b0000 0000 0000 0100 0000 0000”

The OR operator 3224 may perform an OR operation for the bit string which represents the current time 604 and is inputted from the bit string generator 3223 and the bit string indicating viewing hours 603 and output the operation result to the XOR operator 321. The bit string representing the viewing hours 603 may be previously acquired from the file management apparatus 2 at notification of the access permission condition 105, for example.

As an example, when the “viewing hours” is “12:00-18:00” and the current time 604 is “15:00”, the result of OR operation is the same as the bit string of the viewing hours 603 as follows.

Result of OR operation for current time of 15:00:

“0b0000 0011 1111 0000 0000 0000”

As an example, when the “viewing hours” is “12:00-18:00” and the current time 604 is “10:00”, the result of OR operation is different from the bit string of the viewing hours 603 as follows.

Result of OR operation for current time of 10:00:

“0b0000 0011 1111 0100 0000 0000”

The XOR operator 321 may calculate the operation result 113 using the result of OR operation from the OR operator 3224 as follows.

IV=F1̂F2̂ [Result of OR operation for viewing hours]

When the current time 604 is in the viewing hours 603 (the current time 604 is 15:00, for example), the OR operation result is the same as the bit string of the viewing hours 603, and the obtained operation result 113 coincides with the correct initial vector 102.

The bit string generator 3223 does not have to be included in the converter 322 when the current time 604 is inputted from the accessing apparatus 4 in the form of a bit string. The current time 604 may be time acquired from the access permitting apparatus 3 instead of the accessing apparatus 4.

[1-5-4] Case where Access Permission Condition is Allowed number of accesses

(Configuration Example of Converter 223)

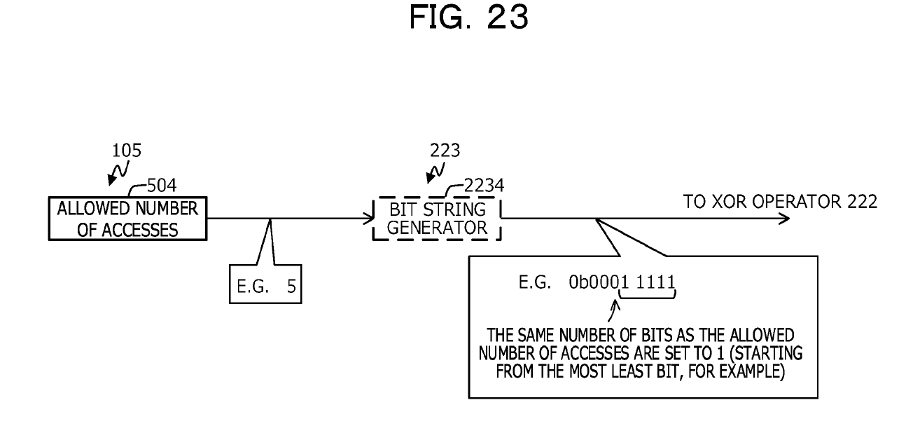

As illustrated in FIG. 23, the converter 223 of the file management apparatus 2 may include a bit string generator 2234.

When the access permission condition 105 includes a maximum allowed number 504 of accesses, the maximum allowed number 504 of accesses may be specified by a numerical value of 5 or the like, for example.

The bit string generator 2234 may generate a bit string representing the inputted maximum allowed number 504 of accesses in bits, for example and output the generated bit string to the XOR operator 222.

As an example, the bit string generator 2234 may generate a bit string in which the same number of bits as the maximum allowed number 504 of accesses, (five, for example) are set to 1. In this bit string, the total five bits including the zeroth to fourth bits may be set to 1 as follows.

Bit string representing maximum allowed number of accesses of “five”

“0b0001 1111”

The XOR operator 222 may calculate the F2 107 using the bit string representing the allowed number of accesses as follows.

F2=F1̂IV̂ [Bit string representing the allowed number of accesses]

The bit string representing the allowed number of accesses may be set in the “maximum allowed number of accesses” in the access permission condition 105. In this case, the bit string generator 2234 does not have to be provided for in the converter 223.

The file management apparatus 2 may notify the access permitting apparatus 3 of the aforementioned bit string as the information of the “maximum allowed number of accesses” in the process of notifying of the access permitting apparatus 3 of the access permission condition 105.

(Configuration Example of Converter 322)

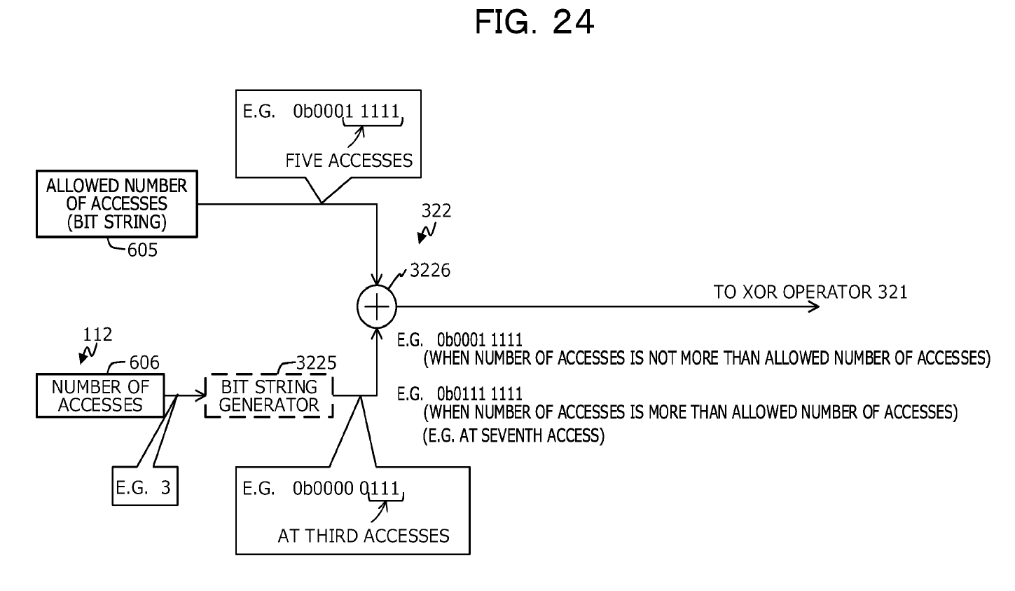

As illustrated in FIG. 24, the converter 322 of the access permission determination unit 32 may include a bit string generator 3225 and an OR operator 3226.

When the state information 112 inputted from the accessing apparatus 4 includes a number 606 of accesses, the bit string generator 3225 may generate a bit string from the number 606 of accesses in the same manner as the bit string generator 2234 of the file management apparatus 2 and output the same to the OR operator 3226.

As an example, the bit string generator 3225 may generate a bit string in which the same number of bits as the number 606 of accesses, such as “three”, for example are set to 1. In the bit string, three bits including the zeroth to second bits may be set to 1 as follows, for example.

Bit string representing a number of accesses of three:

“0b0000 0111”

The OR operator 3226 may perform an OR operation for the bit string which represents the number 606 of accesses inputted from the bit string generator 3225 and the bit string representing the maximum allowed number 605 of accesses and output the operation result to the XOR operator 321. The bit string representing the maximum allowed number 605 of accesses may be previously acquired from the file management apparatus 2 at notification of the access permission condition 105, for example.

As an example, when the “maximum allowed number of accesses” is “five” and the number 606 of accesses is “three”, the result of OR operation is the same as the bit string of the maximum allowed number 605 of accesses as follows.

Result of OR operation for the number of accesses of “three”:

“0b0001 1111”

When the “maximum allowed number of accesses” is “five” and the number 606 of accesses is “seven”, the result of OR operation is different from the bit string of the maximum allowed number 605 of accesses as follows.

Result of OR operation for a number of accesses of “seven”:

“0b0111 1111”

The XOR operator 321 may calculate the operation result 113 using the OR operation result from the OR operator 3226 as follows.

IV=F1̂F2̂ [Result of OR operation for allowed number of accesses]

When the number 606 of accesses is not more than the maximum allowed number 605 of accesses, the result of OR operation coincides with the bit string of the maximum allowed number 605 of accesses, and the obtained operation result 113 coincides with the correct initial vector 102.

The bit string generator 3225 does not have to be provided for the converter 322 when the number 606 of accesses is inputted from the accessing apparatus 4 in the form of a bit string. The number 606 of accesses may be the number of times acquired by the access permitting apparatus 3 instead of the accessing apparatus 4. For example, the access permitting apparatus 3 may count the number of access permission requests from the accessing apparatus 4 for each file 100.

In the aforementioned example, the converter 223 converts the maximum allowed number 504 of accesses into a bit string while the converter 322 ORs the bit strings representing the maximum allowed number 605 of accesses and the number 606 of accesses. However, the configuration is not limited to this.

For example, in the file management apparatus 2, the bit string generator 2234 may not be provided for the converter 223, and the XOR operator 222 may generate the F2 107 using a value of the maximum allowed number 504 of accesses of “five”.

In the access permitting apparatus 3, the maximum allowed number 605 of accesses and the number 606 of accesses may be specified by numerical values of “five”, “three”, and the like. In this case, the bit string generator 3225 is not provided for the converter 322, and the converter 322 may be provided with a comparator that compares the magnitudes of inputted values instead of the OR operator 3226.

The comparator may output the maximum value among inputted values. As an example, when the number 606 of accesses is not more than the maximum allowed number 605 of accesses, the comparator outputs the numerical value of the maximum allowed number 605 of accesses, such as “five” and otherwise, the comparator outputs the numerical value of the number 606 of accesses, such as “seven”, for example.

When the access permission condition 105 includes the “maximum allowed number of accesses” as described above, the F2 107 and operation result 113 may be generated by numerical values instead of bit strings.

[1-5-5] Case where Access Permission Condition is Apparatus ID or User ID

When the access permission condition 105 includes the “apparatus ID” or “user ID”, the converter 223 of the file management apparatus 2 may directly output the ID of the accessing apparatus 4 or user that is permitted to access the file 100, to the XOR operator 222.

When the state information 112 inputted from the accessing apparatus 4 includes the “apparatus ID” or “user ID”, the converter 322 of the access permitting apparatus 3 may directly output the ID of the accessing apparatus 4 or user to the XOR operator 321.

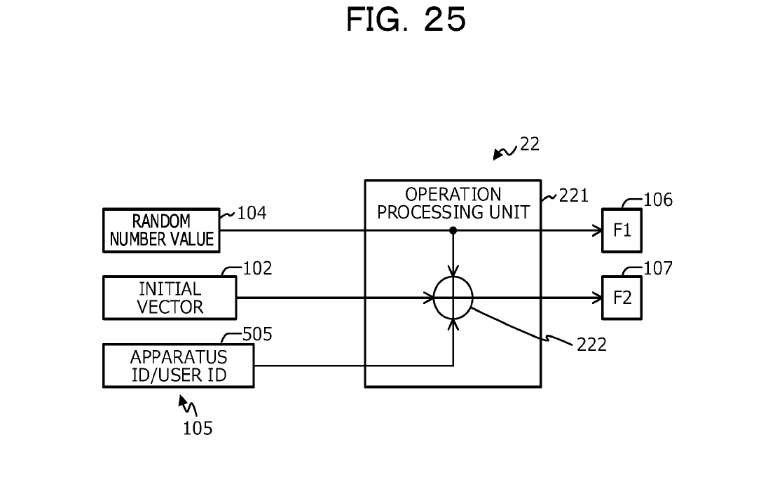

As an example, the XOR operator 222 of the file management apparatus 2 may calculate the F2 107 using apparatus ID/user ID 505 included in the access permission condition 105 as illustrated in FIG. 25 in the following manner.

F2=F1̂IV̂ [Apparatus ID or user ID]

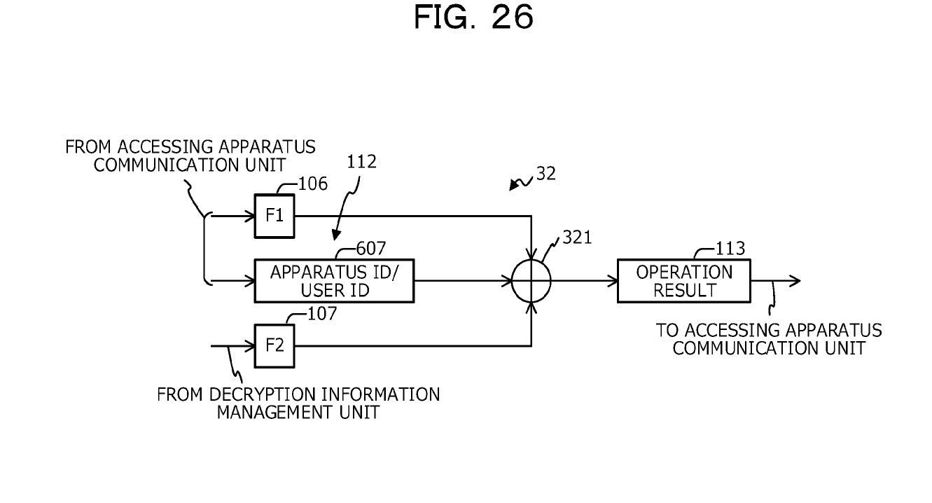

As illustrated in FIG. 26, the XOR operator 321 of the access permitting apparatus 3 may calculate in the following manner using apparatus ID/user ID 607 included in the state information 112 inputted from the accessing apparatus 4 to acquire the operation result 113.

IV=F1̂F2̂ [Apparatus ID or user ID]

[1-6] Operation Example

Next, a description is given of an operation example of the information processing system 1 according to the first embodiment.

[1-6-1] File Registration Process

First, a description is given of an operation example of a process to register the file 100 by the file management apparatus 2.

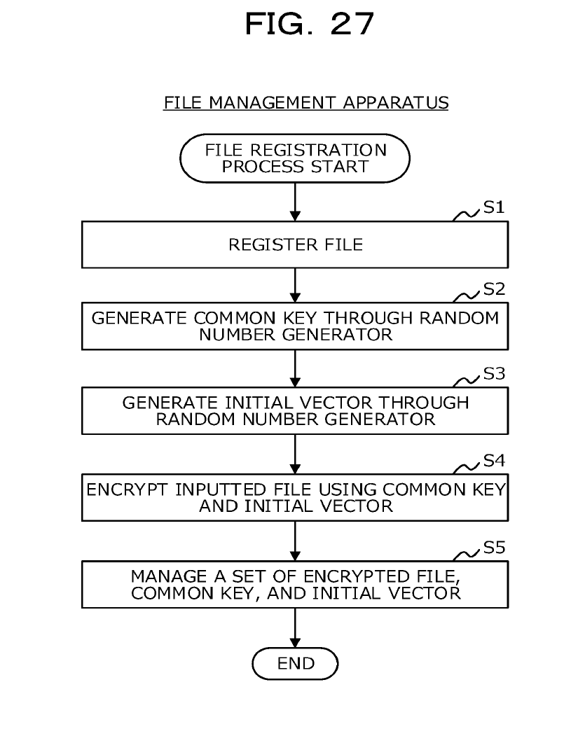

As illustrated in FIG. 27, the file registration unit 21 of the file management apparatus 2 registers an inputted file 100 in the file management information 212 (step S1). The registration of the file 100 may include storage of the file 100 in the memory unit 25.

Next, the file management apparatus 2 generates the common key 101 and initial vector 102 through the random number generator 24 (steps S2 and S3).

Using the common key 101 and initial vector 102, the file registration unit 21 encrypts the file 100 through the encryption unit 221 to acquire the encrypted file 103 (step S4).

The file registration unit 21 registers and manages a set of the encrypted file 103, common key 101, and initial vector 102 in the file management information 212 (step S5). The process is then terminated.

[1-6-2] File Distribution Process

Next, a description is given of an operation example of the process to distribute the encrypted file 103.

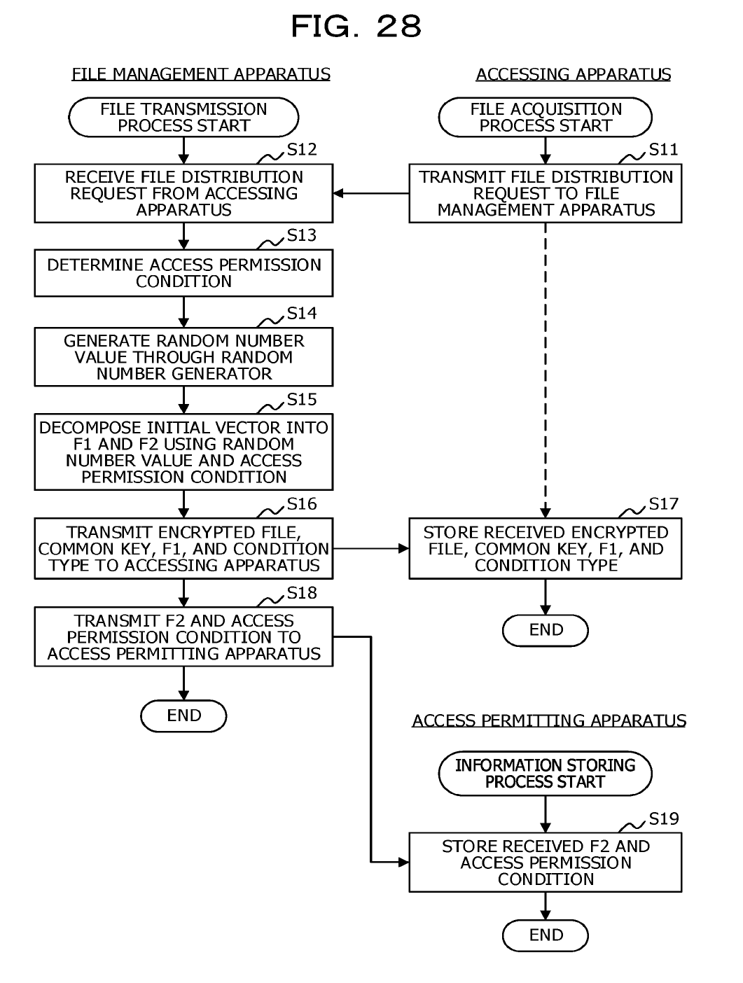

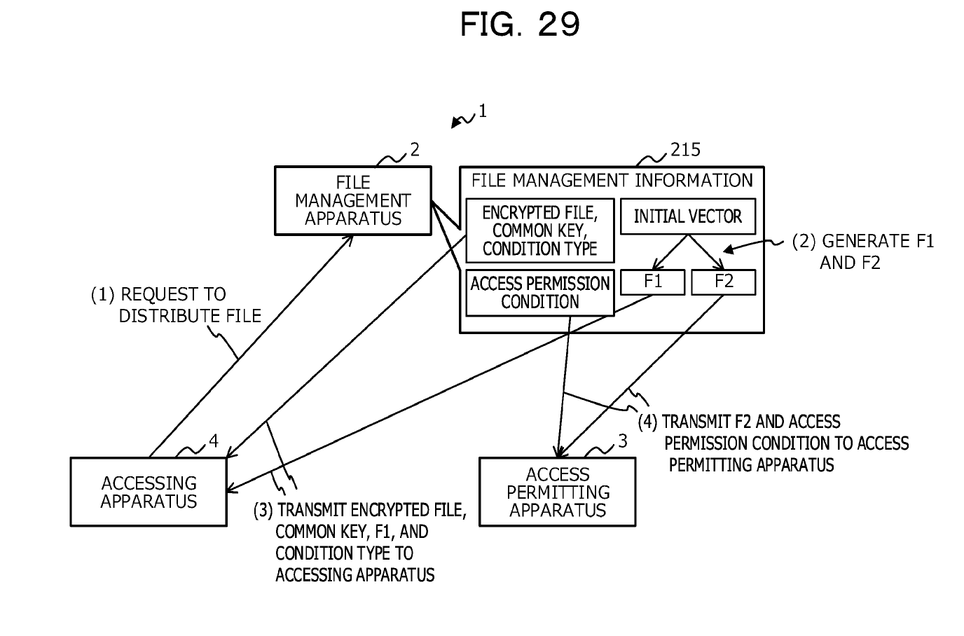

As illustrated in FIG. 28, the accessing apparatus 4 transmits a request to distribute the file 100 to the file management apparatus 2 (step S11; see arrow (1) in FIG. 29).

When receiving the request to distribute the file 100 from the accessing apparatus 4 (step S12), the file management apparatus 2 determines the access permission condition 105 (step S13). The file management apparatus 2 then generates the random number value 104 through the random number generator 24 (step S14).

Using the generated random number value 104 and determined access permission condition 105, the decryption information generator 22 of the file management apparatus 2 decomposes the initial vector 102 into the F1 106 and F2 107 (step S15; see arrow (2) in FIG. 29).

The information transmitter 23 of the file management apparatus 2 transmits the encrypted file 103, common key 101, F1 106, and condition type 110 to the accessing apparatus 4 (step S16; see arrow (3) in FIG. 29). The accessing apparatus 4 stores the received information in the memory unit (step S17).

The information transmitter 23 transmits the F2 107 and access permission condition 105 to the access permitting apparatus 3 (step S18; see arrow (4) in FIG. 29). The access permitting apparatus 3 stores the received information in the memory unit (step S19). The process to distribute the encrypted file 103 is thus terminated.

[1-6-3] File Viewing Process

Next, a description is given of an operation example of the process to view the file 100. The user may execute the process to view the file 100 through the accessing apparatus 4 after previously taking some steps so as to satisfy the access permission condition 105. For example, when the access permission condition 105 includes the “position information”, the user brings the accessing apparatus 4 storing the encrypted file 103 and moves to a decryption place (the place where viewing of the file 100 is permitted).

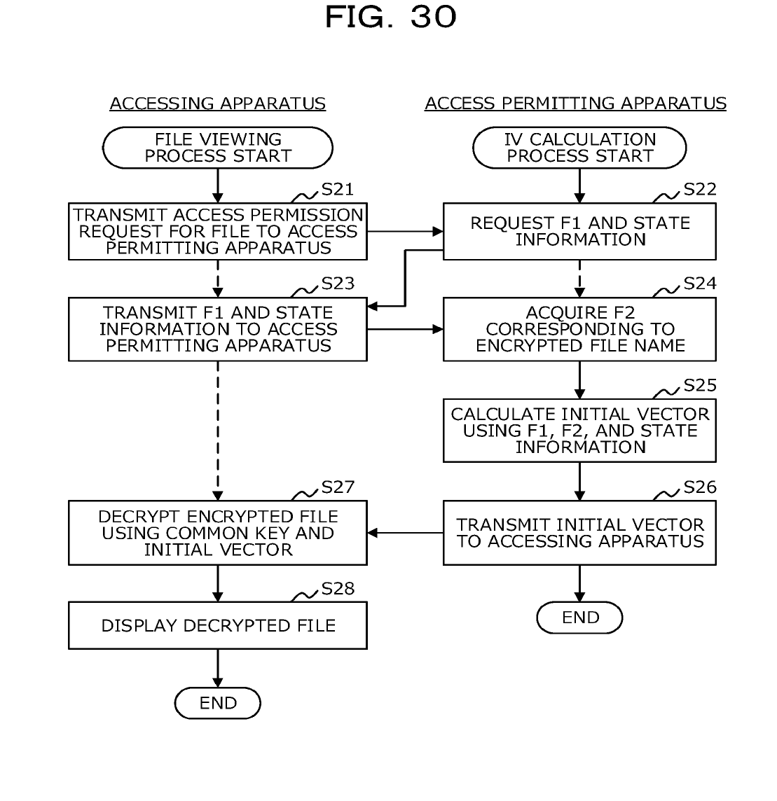

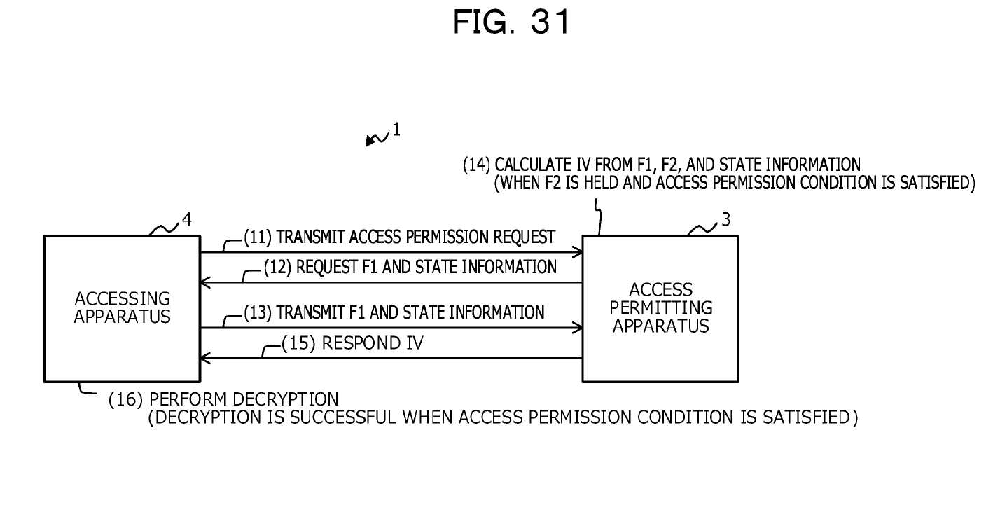

As illustrated in FIG. 30, the accessing apparatus 4 transmits an access permission request for the file 100 to the access permitting apparatus 3 through the access permission requesting unit 43 (step S21; see arrow (11) in FIG. 31).

The access permitting apparatus 3 requests the F1 106 and state information 112 from the accessing apparatus 4 (step S22; see arrow (12) in FIG. 31). The accessing apparatus 4 transmits the F1 106 and state information 112 to the access permitting apparatus 3 (step S23; see arrow (13) in FIG. 31).

The access permitting apparatus 3 acquires the F2 107 corresponding to the encrypted file name 111 from the management information 331 through the decryption information management unit 33 (step S24).

Using the F1 106, F2 107, and state information 112, the access permitting apparatus 3 calculates the initial vector 102 through the access permission determination unit 32 (step S25). The access permitting apparatus 3 then transmits the initial vector 102 to the accessing apparatus 4 (step S26).

Using the common key 101 and initial vector 102, the accessing apparatus 4 decrypts the encrypted file 103 into the file 100 through the decryption unit 44 (step S27). The accessing apparatus 4 then displays the obtained file 100 on the display unit 45 (step S28). The process to view the file 100 is thus terminated.

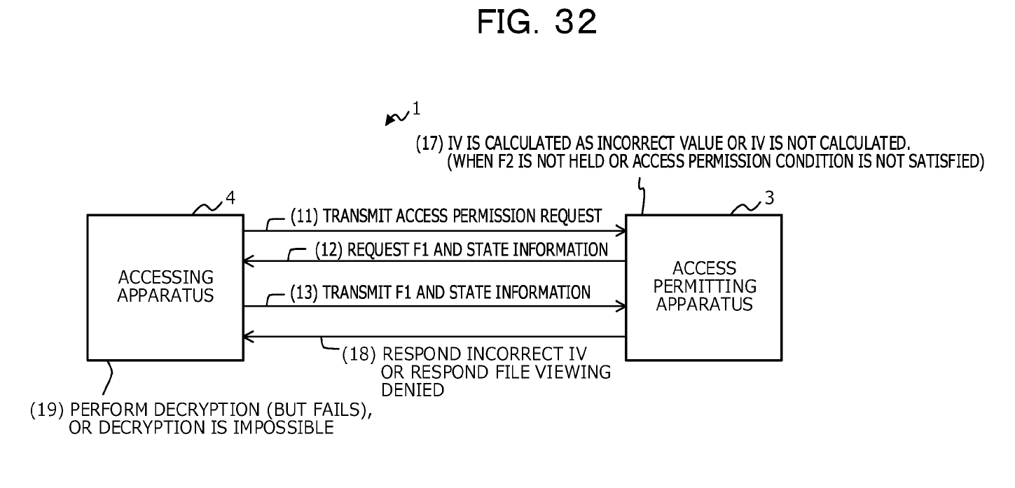

In the step S25, when the F2 107 is included in the management information 331 and the state information 112 satisfies the access permission conditions 105, the operation result 113 coincides with the correct initial vector 102 (see (14) in FIG. 31). In this case, the operation result 113 (the initial vector 102) is transmitted to the accessing apparatus 4 in the step S26 (see arrow (15) in FIG. 32). The accessing apparatus 4 then successfully decrypts the encrypted file 103 in the step S27 (see (16) in FIG. 31).

In the step S25, when the F2 107 is not included in the management information 331 or the state information 112 does not satisfy the access permission condition 105, the operation result 113 is different from the correct initial vector 102 (see (17) in FIG. 32). Alternatively, the access permission determination unit 32 determines that access to the file 100 is impossible.

In this case, in the step S26, the operation result 113, which is the incorrect initial vector 102, for example, or the determination result that access is impossible is transmitted to the accessing apparatus 4 (see arrow (18) in FIG. 32). In the step S27, therefore, the accessing apparatus 4 fails to view the file 100 due to unsuccessful or impossible decryption of the encrypted file 103 (see (19) in FIG. 31). The accessing apparatus 4 then displays an error message or the like on the display unit 45, for example.

[1-6-4] Regular Confirmation Process

Next, a description is given of an operation example of the process to regularly confirm whether the access permission condition 105 is satisfied.

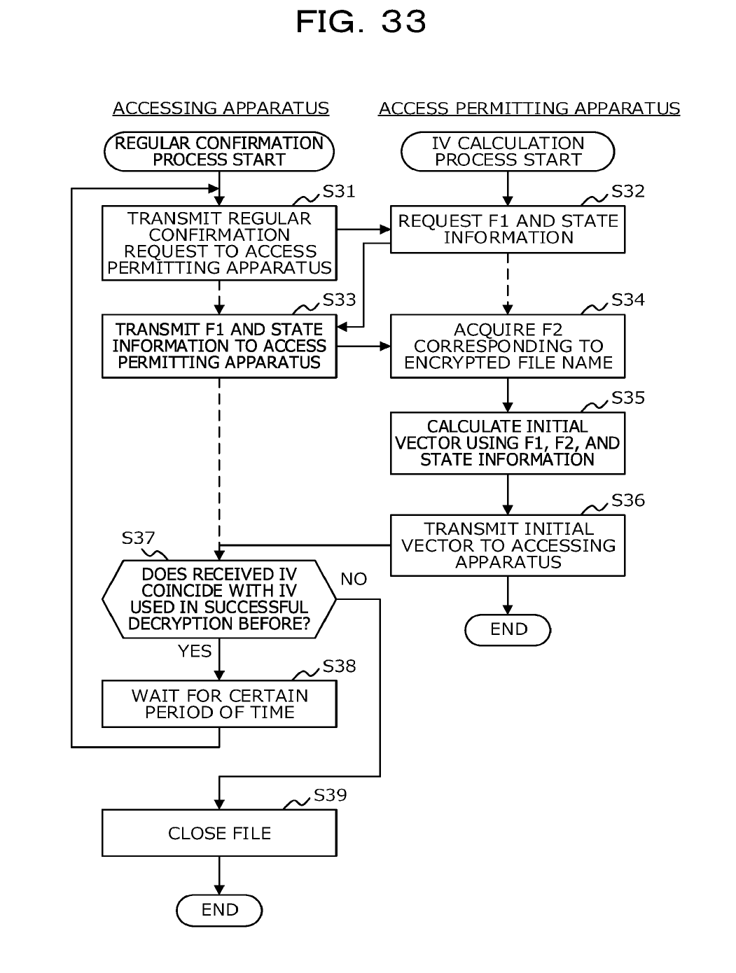

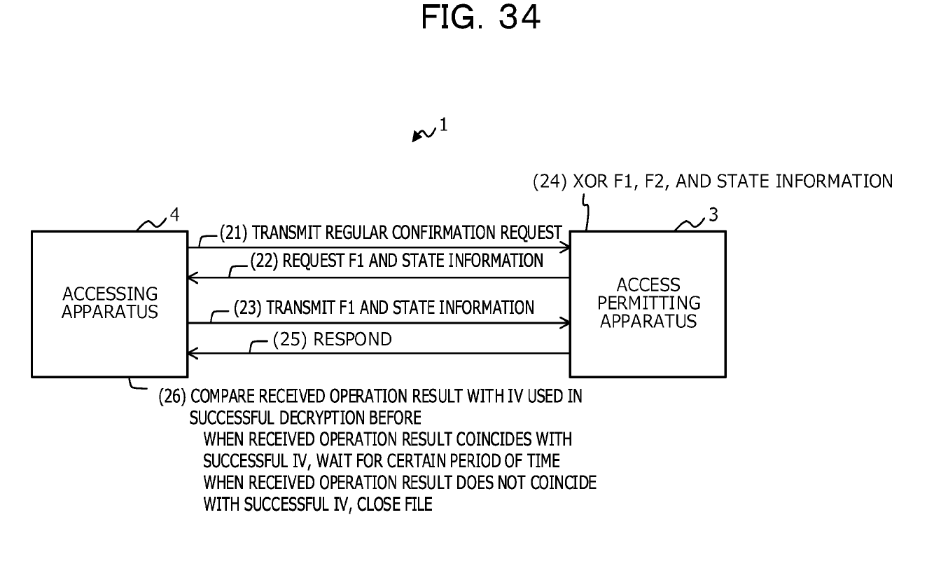

As illustrated in FIG. 33, the accessing apparatus 4 transmits a request to regularly confirm the access permission condition 105 for the successfully decrypted file 100 (which is being viewed, for example), to the access permitting apparatus 3 (step S31; see arrow (21) in FIG. 34).

The access permitting apparatus 3 requests the F1 106 and state information 112 from the accessing apparatus 4 (step S32; see arrow (22) in FIG. 34), and the accessing apparatus 4 responds the F1 106 and state information 112 (step S33; arrow (23) in FIG. 34).

The access permitting apparatus 3 acquires the F2 107 from the management information 331 (step S34) and calculates the initial vector 102 from the F1 106, F2 107, and state information 112 (step S35; see (24) in FIG. 34). The access permitting apparatus 3 responds the operation result 113 to the accessing apparatus 4 (step S36; see arrow (25) in FIG. 34).

The accessing apparatus 4 compares the received operation result 113 with the initial vector 102 with which the target encrypted file 103 has been successfully decrypted before and determines whether the received operation result 113 coincides with the initial vector 102 (Step S37; see (26) in FIG. 34). When the operation result 113 coincides with the initial vector 102 (YES in the step S37), the accessing apparatus 4 waits for a certain period of time (step S38), and the process moves to the step S31.

When the operation result 113 does not coincide with the initial vector 102 (NO in the step S37), the accessing apparatus 4 closes the file 100 which is being viewed (step S39), and the process is terminated.

[1-6-5] Access Permission Condition Updating Process

Next, a description is given of an operation example of the process to update the access permission condition 105. To change the access permission condition 105 already set to the user or a file 100, the user or the administrator of the file 100 may request the file management apparatus 2 to change the access permission condition 105. The request may be a request for an operator of the file management apparatus 2.

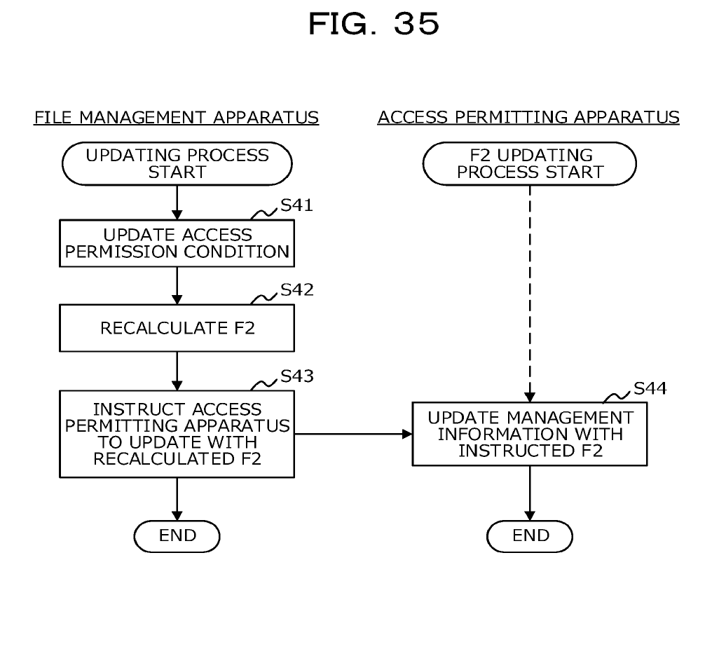

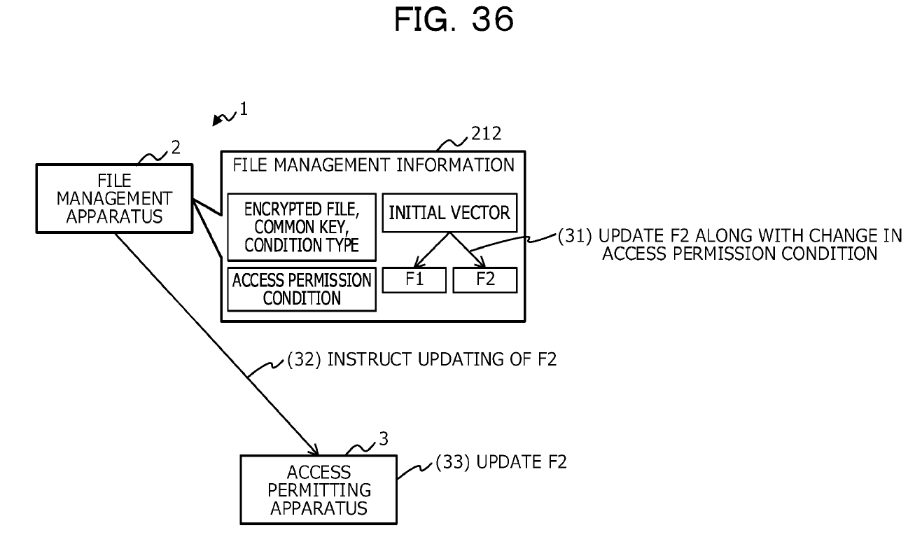

As illustrated in FIG. 35, when permitting the access permission condition 105 to be changed, the file management apparatus 2 updates the access permission condition 105 (step S41). The decryption information generator 22 of the file management apparatus 2 recalculates the value of the F2 107 without changing the values of the F1 106 and initial vector 102 (step S42; see arrow (31) in FIG. 36).

As an example, when the “viewing hour” is added to the access permission condition 105 in addition to the “position information”, the decryption information generator 22 may perform the following operation.

F2=F2̂ [Viewing hours]

Next, the file management apparatus 2 requests the access permitting apparatus 3 to update the F2 107 (step S43; see arrow (32) in FIG. 36). The access permitting apparatus 3 updates the management information 331 with the recalculated F2 107 (step S44; see (33) in FIG. 36). The process to update the access permission condition 105 is thus terminated.

The file management apparatus 2 may add the updated access permission condition 105 to an instruction to update the F2 107 instead of the value of the F2 107. In this case, the access permitting apparatus 3 may recalculate and update the F2 107 of the management information 331 based on the received access permission condition 105. The file management apparatus 2 does not recalculate the F2 107.

[1-6-6] Access Permission Condition Canceling Process

Next, a description is given of an operation example of the process to cancel the access permission condition 105. To cancel the access permission condition 105 which is already set for the user or file 100, the following process may be performed.

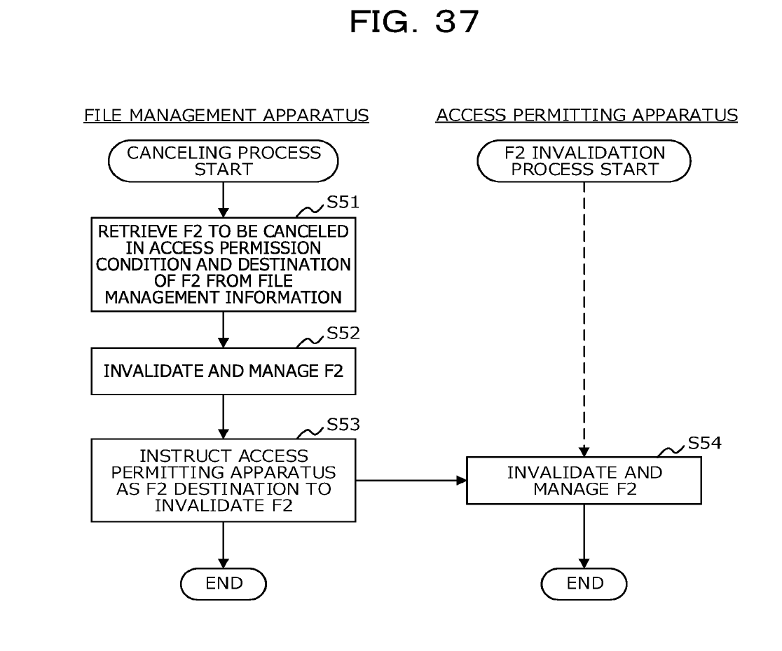

As illustrated in FIG. 37, the file management apparatus 2 retrieves from the file management information 212, the value of the F2 which is to be canceled in the access permission condition 105 and information of the “F2 destination” (step S51).

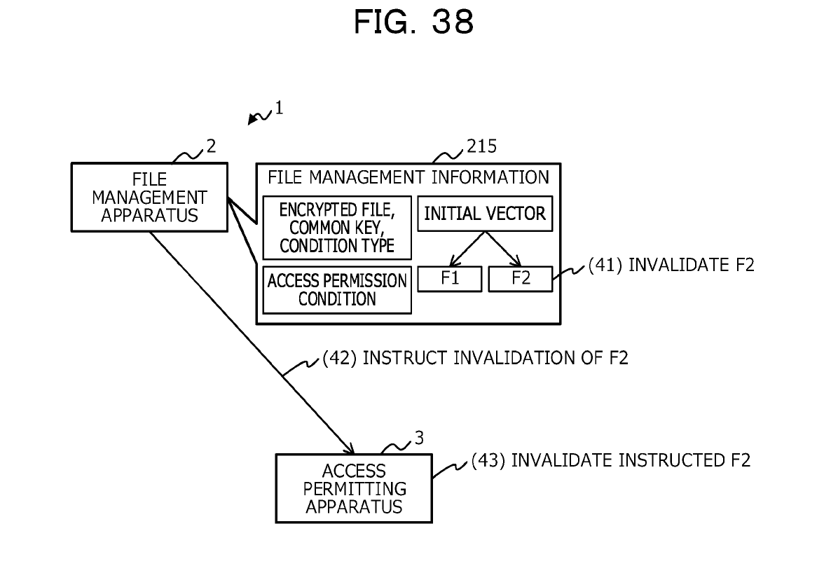

Next, the file management apparatus 2 invalidates and manages the value of the retrieved F2 (step S52; see (41) in FIG. 38). The F2 107 may be invalidated by deleting the F2 107 as described above or setting a flag or the like, for example, to “invalid” to set the access permission condition 105 again. The process in the step S52 may not be performed.

The file management apparatus 2 instructs the access permitting apparatus 3 which is the retrieved “F2 destination” to invalidate the value of the F2 107 corresponding to the user or file 100 (step S53; see arrow (42) in FIG. 38).

The access permitting apparatus 3 invalidates the F2 107 (step S54; see (43) in FIG. 38). The access permitting apparatus 3 therefore incorrectly calculates the initial vector 102 of the file 100, so that the user is incapable of decrypting the encrypted file 103 through the accessing apparatus 4.

The access permission condition 105 may be deleted without transmitting information to the accessing apparatus 4 or changing information on the accessing apparatus 4. Accordingly, it is possible to address the stolen or lost accessing apparatus 4, thus reducing the risk of information leakage.

### [2] Second Embodiment

In the description of the first embodiment, as the decryption information used to decrypt the encrypted file 103, the initial vector 102 is decomposed to the F1 106 and F2 107, which are then distributed to the accessing apparatus 4 and access permitting apparatus 3, respectively.

In the second embodiment, as the decryption information used to decrypt the encrypted file 103, the common key 101 may be decomposed into F1 and F2, which are then distributed to the accessing apparatus 4 and access permitting apparatus 3, respectively.

In this case, the encrypted file 103, initial vector 102, the F1 of the common key 101, and the condition type 110 may be distributed to the accessing apparatus 4. The F2 of the common key 101 and access permission condition 105 may be distributed to the access permitting apparatus 3.

The second embodiment differs from the first embodiment in treatment of the F1, F2, common key 101, and initial vector 102. For example, as for decomposition of the common key 101 into the F1 and F2 in the file management apparatus 2 (generation of the F2) and generation of the common key 101 in the access permitting apparatus 3, the common key 101 and the initial vector 102 are replaced with each other in the description of the first embodiment.

In the second embodiment, the F1, F2, and common key 101 have the following relationships.

F1=Random Number Value

F2=common keŷF1̂ access permission condition

common key=F1̂F2̂ access permission condition

As described above, the second embodiment also provides the same effect as the first embodiment. According to the second embodiment, the common key 101 is decomposed. In cooperation with the first embodiment that decomposes the initial vector 102, the second embodiment provides options of the target to be decomposed for users, thus improving the security.

### [3] Third Embodiment

In the first and second embodiments, the access permitting apparatus 3 responds the initial vector 102 or common key 101 in response to a request from the accessing apparatus 4. However, the disclosure is not limited to such a configuration.

For example, in response to the access permission request or regular confirmation request from the accessing apparatus 4, the access permitting apparatus 3 may respond the value of the corresponding F2 107. In this case, some or all of the functions of the access permitting apparatus 3 may be provided for the accessing apparatus 4. For example, the access permission determination unit 32 may be provided in the accessing apparatus 4, and the accessing apparatus 4 may calculate the initial vector 102 and common key 101 using the F1 106, the state information 112, and the received F2 107.

Since the initial vector 102 or common key 101 is calculated in the accessing apparatus 4, it is possible to reduce a risk of leakage or loss of the initial vector 102 or common key 101 on the transmission path between the access permitting apparatus 3 and accessing apparatus 4.

The access permitting apparatus 3 determines whether the accessing apparatus 4 satisfies the access permission condition 105 based on the state information 112 acquired from the accessing apparatus 4. The access permitting apparatus 3 may transmit the F2 107 to the accessing apparatus 4 when the accessing apparatus 4 satisfies the access permission condition 105.

### [4] Fourth Embodiment

Some or all of the functions of the access permitting apparatus 3 may be provided in the file management apparatus 2 or may be distributed to the file management apparatus 2 and accessing apparatus 4.

This reduces the risk of leakage or loss of the access permission condition 105 and F2 107 on the transmission path between the file management apparatus 2 and access permitting apparatus 3.

### [5] Fifth Embodiment

In the first to fourth embodiments, the F1 106, common key 101, or initial vector 102 stored in the accessing apparatus 4 may be encrypted through a cryptographic module mounted in the accessing apparatus 4. The cryptographic module is a trusted platform module (TPM) or the like, for example.

Moreover, when the cryptographic module is also mounted on the access permitting apparatus 3, the contents of communication between the accessing apparatus 4 and access permitting apparatus 3 in the process to view the file 100 or the like may be encrypted by the cryptographic module.

As described above, according to the fifth embodiment, the security risk is further reduced.

As the cryptographic systems, public key cryptosystems are known. It is known that the public key cryptosystems take longer processing time than the common key cryptosystems. Accordingly, the public key cryptosystems are often used in encryption of the common key of block ciphers, electronic signature systems, and the like and are rarely used to encrypt files 100 themselves.

The accessing apparatus 4 may therefore include a function of encrypting the F1 106, common key 101, or initial vector 102 which includes less information than files 100 through a public key cryptosystem.

[6] Hardware Configuration Example

Next, a description is given of a hardware configuration example of the information processing system 1 according to the first to fifth embodiments. The file management apparatus 2, access permitting apparatus 3, accessing apparatus 4 may include an identical hardware configuration. In the following description, the hardware configuration of each of the file management apparatus 2, access permitting apparatus 3, accessing apparatus 4 is a computer 10 as an example.

The computer 10 may illustratively include a central processing unit (CPU) 10a, a memory 10b, a storage unit 10c, an interface (IF) unit 10d, an input/output unit 10e, and a reading unit 10f.

The CPU 10a is an example of a processor performing various controls and operations. The CPU 10a may be connected to each block of the computer 10 through a bus so as to communicate with the block. Instead of operation processing devices such as the CPU 10a, the processor may be an electronic circuit, such as an integrated circuit (IC) including a micro-processing unit (MPU), an application specific integrated circuit (ASIC), or a field programmable gate array (FPGA).

The memory 10b is an example of hardware storing information including various data and programs. The memory 10b is a volatile memory such as a RAM, for example. The memory 10b is an example of the memory unit 25 of the file management apparatus 2 and memory units of the access permitting apparatus 3 and accessing apparatus 4.

The storage unit 10c is an example of hardware storing information including various data and programs. The storage unit 10c is one of various storage devices including magnetic disk devices such as HDD, semiconductor drive devices such as SSDs, and non-volatile memories such as flash memories and ROMs. In the file management apparatus 2, the storage unit 10c may be a storage device including multiple memory devices.

The storage unit 10c, for example, may store a processing program 10h which implements all or some of various functions of the computer 10. The processing program 10h may include a program implementing the function of the file management apparatus 2, access permitting apparatus 3, or accessing apparatus 4 according to the first to fifth embodiments.

The CPU 10a implements the functions of the computer 10 by loading and executing the processing program 10h stored in the storage unit 10c on the memory 10b, for example. When at least some of the functions of the computer 10 are implemented in a cloud environment or the like, the program 10h may be provided for both of the computer 10 and cloud environment or may be properly divided and provided for the computer 10 and cloud environment.

The IF unit 10d is an example of a communication interface that performs control and the like of connections and communication between the networks between the file management apparatus 2, access permitting apparatus 3, and accessing apparatus 4. For example, the IF unit 10d is an adaptor compliant with the local area network (LAN), universal serial bus (USB), BLUETOOTH (registered trademark) or the like.

The processing program 10h may be downloaded to the computer 10 via the IF unit 10d from a network and the like.

The input/output unit 10e may include at least some of input units such as a mouse, a keyboard, and operation buttons and output units (the display unit 45 in FIG. 16, for example) such as a display and a printer. For example, the input units may be used in various operations, such as registration of the file 100, updating of the access permission condition 105, and requesting for viewing of the file 100. The output units may be used in display in accordance with various operations at the computer 10, such as display of the file 100 and messages (error messages, for example).

The reading unit 10f is an example of a reader that reads information of data and programs recorded in a recording medium 10g. The reading unit 10f may include a connection terminal or device where the computer-readable recording medium 10g is capable of being connected or inserted. The reading unit 10f is an adaptor compliant with USB or the like, a drive device that accesses a recording disk, a card reader that accesses a flash memory such as an SD card, for example. The recording medium 10g may store the processing program 10h.

The recording medium 10g is illustratively one of non-temporary recording media such as flexible disks, optical disks including CDs, DVDs, or Blu-ray disks, and flash memories including USB memories or SD cards. CDs illustratively include CD-ROM, CD-R, and CD-RW. DVDs illustratively include DVD-ROM, DVD-RAM, DVD-R, DVD-RW, DVD+R, and DVD+RW.

The aforementioned hardware configuration of the computer 10 is illustrative. It is therefore possible to properly increase or reduce (add or remove any block, for example) the hardware, divide the hardware, integrate a proper combination of hardware, or add or remove a bus in the computer 10.

[7] Others

The technique according to the aforementioned first to fifth embodiments may be modified or changed as follows.

For example, in the first to fifth embodiments, the initial vector 102 or common key 101 is decomposed into two, including the F1 and F2. However, the disclosure is not limited to this. The initial vector 102 or common key 101 may be decomposed into three or more, including F1 to Fx (x is an integer not less than 3). In this case, F1 to Fx may be distributed to two or three or more apparatuses.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

1. An information processing system, comprising:
an information processing apparatus including:
a first memory; and
a first processor coupled to the first memory;
a terminal including:
a second memory; and
a second processor coupled to the second memory; and
a determination apparatus including:
a third memory; and
a third processor coupled to the third memory; wherein the first processor is configured to:
generate first information and second information based on first decryption information and specified condition information, an encrypted data file is decrypted by using the first decryption information, the specified condition information indicating a condition for allowing the terminal to encrypted data file;
transmit the first information to the terminal; and
transmit the second information to the determination apparatus; wherein the second processor is configured to:
receive the first information transmitted from the information processing apparatus; and
transmit the first information and input information to the determination apparatus when the terminal requests the decryption of the encrypted data file; and wherein
the third processor is configured to:
generate second decryption information based on the first information, the second information and the input information, the generated second decryption information being identical when the input information matches the specified condition information; and
transmit the generated second decryption information, the transmitted second decryption information being used for the decryption of the encrypted data file.

2. The information processing system according to claim 1, wherein the first processor is configured to:
generate the first information and the second information by calculating the first information and the second information based on the first decryption information and the specified condition information.

3. The information processing system according to claim 2, wherein
the first information is a random number value; and wherein
the second information is an operation result of an exclusive OR operation for the first decryption information, the random number value, and the specified condition information.

4. The information processing system according to claim 1, wherein
the specified condition information is information concerning at least one of a geographical position where the encrypted data file is permitted to be decrypted, an hour when the file is permitted to be decrypted, a number of times that the file is permitted to be decrypted, a terminal with which is permitted to decrypt the file, and a user who is permitted to decrypt the file.

5. The information processing system according to claim 2, wherein the first processor is configured to:
when the specified condition information is updated, update the second information based on the decryption information and the updated condition information, and
instruct the determination apparatus to update the second information.

6. The information processing system according to claim 2, wherein the first processor is configured to:
instruct the determination apparatus to invalidate the second information when decryption of the encrypted data file is denied.

7. A terminal, comprising:
a memory; and
a processor coupled to the memory and the processor configured to:
receive first information transmitted from an information processing apparatus, the first information and second information being generated, by the information processing apparatus, based on first decryption information and specified condition information, an encrypted data file is decrypted by using the first decryption information, the specified condition information indicating a condition for allowing the terminal to encrypted data file;
transmit the first information and input information to a determination apparatus when the terminal requests the decryption of the encrypted data file;
receive second decryption information generated, by the determination apparatus, based on the first information, the second information and the input information, the second information being stored in the determination apparatus, the generated second decryption information being identical when the input information matches the specified condition information; and
perform the decryption of the encrypted data file by using the second decryption information.

8. A determination apparatus, comprising:
a memory; and
a processor coupled to the memory and the processor configured to:
receive second information transmitted from an information processing apparatus, first information and the second information being generated, by the information processing apparatus, based on first decryption information and specified condition information, an encrypted data file is decrypted by using the first decryption information, the specified condition information indicating a condition for allowing the terminal to encrypted data file;
receive the first information and input information from a terminal when the terminal requests the decryption of the encrypted data file, the first information being stored in the terminal;
generate second decryption information based on the first information, the second information and the input information, the generated second decryption information being identical when the input information matches the specified condition information; and
transmit the generated second decryption information to the terminal, the transmitted second decryption information being used for the decryption of the encrypted data file.
